(19) United States
(12) Patent Application Publication
(10) Pub. No.: US 2016/0029094 A1
(43) Pub. Date: Jan. 28, 2016

(54) ENABLING INTERACTION BETWEEN SOCIAL NETWORK USERS DURING SYNCHRONOUS DISPLAY OF VIDEO CHANNGEL

(71) Applicant: LiveRelay Inc., San Diego, CA (US)

(72) Inventors: KaYeung Cheung, San Diego, CA (US); Long Chain Lee, San Diego, CA (US); Steven Lee Shen, San Marcos, CA (US)

(21) Appl. No.: 14/874,013

(22) Filed: Oct. 2, 2015

Related U.S. Application Data
(63) Continuation of application No. 14/103,769, filed on Dec. 11, 2013, now abandoned.
Application No. 14/103,769 is a continuation-in-part of application No. 13/867,921, filed on Apr. 22, 2013, now abandoned.

(51) Int. Cl. H04N 21/4788; H04N 21/485; H04N 21/61; H04N 21/431

(52) U.S. Cl. CPC H04N 21/4788; H04N 21/4316; H04N 21/4858; H04N 21/6175

(57) ABSTRACT

The current subject matter describes displaying multimedia data on a graphical user interface of a user device (for example, a smart television set) during a display of a video channel in accordance with an aesthetic display design and based on effective interaction between the user device and an input device (for example, remote control device) configured to interact with the user device. Related methods, apparatuses, systems, techniques and articles are also described.

### RELATED APPLICATIONS

This patent application is a continuation of U.S. patent application Ser. No. 14/103,769, entitled “Enabling Interaction Between Social Network Users During Synchronous Display Of Video Channel,” filed on Dec. 16, 2013, which is a continuation-in-part of U.S. patent application Ser. No. 13/867,921, entitled “Television Relay for a Social Network,” filed on Apr. 22, 2013, the contents of which are incorporated in entirety by reference.

### TECHNICAL FIELD

The subject matter described herein relates to an aesthetic and synchronous display of multimedia data on graphical user interfaces of user devices (for example, smart television sets) of social network users, wherein the multimedia data is displayed based on effective interactions between the user devices and corresponding input devices (for example, remote control devices) interacting with respective user devices.

### BACKGROUND

Conventional television service networks include a number of available television channels that can be broadcast to a large number of individuals. Ordinarily, an individual can view some of the broadcasted channels only if the individual is subscribed to those channels. The individuals that do not subscribe to those channels have limited and ineffective options to preview any of the channels. Thus, most individuals that do not subscribe to one or more of those channels continue to be disinterested in those channels, and accordingly, are non-committal about subscribing to any of those channels requiring a channel subscription. As a result, the service providers lose or minimize revenue that can be generated by making the non-subscribers interested in and purchasing those additional channels requiring a subscription. Additionally, conventional television broadcasting service is not designed for social networking features.

### SUMMARY

The current subject matter describes displaying multimedia data on a graphical user interface of a user device (for example, a smart television set) during a display of a video channel in accordance with an aesthetic display design and based on effective interaction between the user device and an input device (for example, remote control device) configured to interact with the user device. Additionally, the subject matter described herein describes synchronously displaying the multimedia data to two or more users. Related methods, apparatuses, systems, techniques and articles are also described.

In one aspect, at least one data processor connected to a user device of a user receives content of a video channel from a content server when the user is either subscribed to the video channel or connected to a subscriber of the video channel on a social network. The at least one data processor receives, from a user input device connected to the user device, a first set of one or more commands input by the user on the user input device. The at least one data processor transmits the content of the video channel to a graphical user interface of the user device. The content of the video channel is arranged based on the first set of one or more commands and based on a display design. The graphical user interface displays the arranged content of the video channel according to the display design.

In some variations, one or more of the following can be implemented individually or in any feasible combination. The at least one data processor is embedded in a set top box, and the user input device is a remote control device. The at least one data processor is connected to the user device via a wireless communication network. In an alternate implementation, the at least one data processor is embedded in the user device in order to execute a software application performing tasks of a set top box, wherein the user input device is at least one of a keyboard of a computer used by the user, and a touchscreen on the computer. The user input device includes a keypad to receive the first set of one or more commands in a textual format. The arranged content is displayed on the graphical user interface in a plurality of graphical elements including: a video playback area, a main interaction area, a clock panel, a menu bar panel, a notification panel, a contacts panel, a voice living room panel, and a discovery grid window.

The video playback area displays a video of the video channel. The main interaction area displays instruction data received from the user on the user input device. The instruction data determines one or more graphical elements of the plurality of graphical elements and associated content that are to be displayed simultaneously on the graphical user interface. The clock panel displays a current time. The menu bar panel includes: a friends tab to hide a display of contacts of the user on the social network in the main interaction area, a privacy tab to activate or deactivate privacy of the user in order to share or prevent data identifying the video channel being displayed to the user, a chat tab to select recipients of one or more messages to be sent by the user, and a history tab to display a chat history of the user in the notification panel. The notification panel displays messages between the user and one or more contacts of the user on the social network. The contacts panel displays contacts of the user that are currently being displayed respective/corresponding video channels. The voice living room panel displays contacts on the social network that are in a current voice session with the user. The discovery grid window displays channels filtered according to at least one of: favorite channels, popular channels, genre, type, alphabetically, numerical order of channel numbers, and subscription status of the user. The notification panel executes a fade-out animation so that messages received or sent more than a predetermined time ago are automatically removed from display in the notification panel. The genre includes at least one of: language of programs displayed, lifestyle, news, sports, and business.

The content of the video channel is displayed simultaneously in two or more graphical elements when there is no conflict in a control of the two or more graphical elements by the user input device. The main interaction area includes: an emoticon area, a message composition panel, a contacts list panel, and an electronic program guide (EPG) channel surf panel. The content of the video channel includes unique emoticons comprising: vegetables, fruits, flowers, animals, and food. The graphical user interface displays an enlarged copy of a unique emoticon in the video playback area when the user: presses a unique emoticon button on the user input device to activate a unique emoticon mode, selects the unique emoticon from the emoticon area, and performs a preset movement with the user input device. The preset movement of the user input device includes one or more of: a rotation of the user input device, and a quick movement of the user input device in a particular direction.

Further, the at least one data processor can receive a second set of one or more commands characterized by a three-dimensional movement of the user input device by the user. The at least one data processor can determine the three-dimensional movement based on a tracking of the user input device by one or more gyroscopic sensors embedded in the user input device. The at least one data processor can generate data characterizing a figure based on the second set of one or more commands. The at least one data processor can transmit the data characterizing the generated figure to the graphical user interface that can display the figure. The graphical user interface of a user device of another user that is a contact of the user on the social network displays the figure when the figure is displayed on the graphical user interface of the user device of the user. The at least one data processor can receive another set of one or more commands characterized by an accelerating movement of the user input device by the user. The at least one data processor can determine the accelerating movement based on a tracking of a movement of the user input device by at least one accelerometer embedded in the user input device. The at least one data processor can transmit the another set of one or more commands to the user device. The user device vibrates on receipt of the another set of one or more commands. A user device of another user that is a contact of the user on the social network vibrates when the user device of the user vibrates. Further, the user device is attached to one or more cameras that enable video-conferencing between the user and one or more contacts of the user on the social network.

In another aspect, a graphical user interface of a first user device of a first user connected to a second user on a social network can receive one or more commands provided by the first user on a remote control device connected to the first user device via a first communication network. The graphical user interface of the first user device can retrieve, based on the one or more commands, data of a video channel being displayed on a graphical user interface of a second user device of the second user. According to a display design on the graphical user interface of the first user interface device, the data of the video channel can be displayed in synchronization with display of the video channel on the graphical user interface of the second user device.

In yet another aspect, a system includes: a first user device of a first user, the first user being followed by a plurality of followers on a social network, the first user device connected to a first remote control device configured to receive a commentary by the first user; a plurality of user devices of the plurality of followers, each user device of the plurality of user devices being connected to a corresponding remote control device of a plurality of remote control devices; and a plurality of servers connected to the first user device and the plurality of user devices via a communication network, the plurality of servers relaying and synchronously an event hosted on the video channel to the first user and the plurality of followers, the plurality of servers receiving the commentary from the first remote control device when the event is being displayed, the plurality of servers relaying the commentary to the plurality of user devices of the plurality of followers in real-time.

In some variations, one or more of the following can be implemented individually or in any suitable combination. The plurality of servers can include a content server and a management system. The first user device is associated with a set top box. Each of the plurality of user devices is associated with a corresponding set top box.

Computer program products are also described that comprise non-transitory computer readable media storing instructions, which when executed by at least one data processors of one or more computing systems, causes at least one data processor to perform operations herein. Similarly, computer systems are also described that may include one or more data processors and a memory coupled to the one or more data processors. The memory may temporarily or permanently store instructions that cause at least one processor to perform one or more of the operations described herein. In addition, methods can be implemented by one or more data processors either within a single computing system or distributed among two or more computing systems.

The subject matter described herein provides many advantages. For example, the system described herein allows a non-subscriber to view a channel if a social network contact of the non-subscriber has a subscription to the content-streaming service providing the channel and if the social network contact is viewing the channel. This viewing of a channel without the non-subscriber immediately purchasing the subscription can encourage the non-subscriber to subsequently purchase the subscription, thereby increasing the revenue and profits of a business entity providing the content streaming service. The system provider can manage rights and license of the content or channel so that the non-subscriber can view the content during the preview period. The system also allows distantly living friends and/or families to interact together by simultaneously and separately viewing shows and/or events (for example, sports games, political debates, cooking shows, music videos, news shows, and any other show or event) on channels that they like while interacting with each other in a virtual living room. Additionally, the system displays various features on corresponding locations of a graphical user interface in accordance with an aesthetic display design that can appeal to users (for example, subscribers and non-subscribers) and encourage them to use the system. Moreover, the social networking aspect allows users to find new content and channels based on common interests, and stay in touch with contacts and user communities having similar interests.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a diagram illustrating a system for a relay and display of a channel based on a social network;

FIG. 2 is a system diagram illustrating a system for a relay and display of a channel based on a social network;

FIG. 3 is a system diagram illustrating a system for a relay and display of a channel based on a social network;

FIG. 4 is a flow diagram illustrating a method of relaying and displaying a channel to a non-subscriber when a subscriber is viewing the channel;

FIG. 5 is a flow diagram illustrating a first sequence of steps performed to simultaneously display the channel to different users and allow a communication between those users;

FIG. 6 is a flow diagram illustrating a second sequence of steps performed to simultaneously display the channel to different users and allow a communication between those users;

FIG. 7 is a flow diagram illustrating a third sequence of steps performed to simultaneously display the channel to different users and allow a communication between those users;

FIG. 8 is a flow diagram illustrating a fourth sequence of steps performed to simultaneously display the channel to different users and allow a communication between those users;

FIG. 9 is a diagram illustrating a first graphical user interface that allows a group-watch of a channel by different users in a virtual living room;

FIG. 10 is a diagram illustrating a second graphical user interface that allows group-watch of a channel by different users in a virtual living room;

FIG. 11 is a diagram illustrating a third graphical user interface that allows a group-watch of a channel by different users in a virtual living room;

FIG. 12 is a diagram illustrating a third graphical user interface that allows a group-watch of a channel by different users in a virtual living room;

FIG. 13 is a diagram illustrating a third graphical user interface that displays channels available for a user;

FIG. 14 illustrates an aesthetic display design of one example of a graphical user interface executed by the user device;

FIG. 15 illustrates a graphical user interface displaying the emoticon area, the message composition panel, and the notification panel;

FIG. 16 illustrates a graphical user interface displaying a unique emoticon splashed in the video playback area;

FIG. 17 illustrates a graphical user interface displaying the contacts list panel;

FIG. 18 illustrates a graphical user interface displaying the electronic program guide (EPG) channel surf panel and the clock panel;

FIG. 19 illustrates a graphical user interface displaying the emoticon area, the message composition panel, and the contacts list panel;

FIG. 20 illustrates a graphical user interface displaying the menu bar panel;

FIG. 21 illustrates a graphical user interface displaying the voice living room panel; and

FIG. 22 illustrates a graphical user interface displaying a discovery grid window.

Like reference symbols in the various drawings indicate like elements.

### DETAILED DESCRIPTION

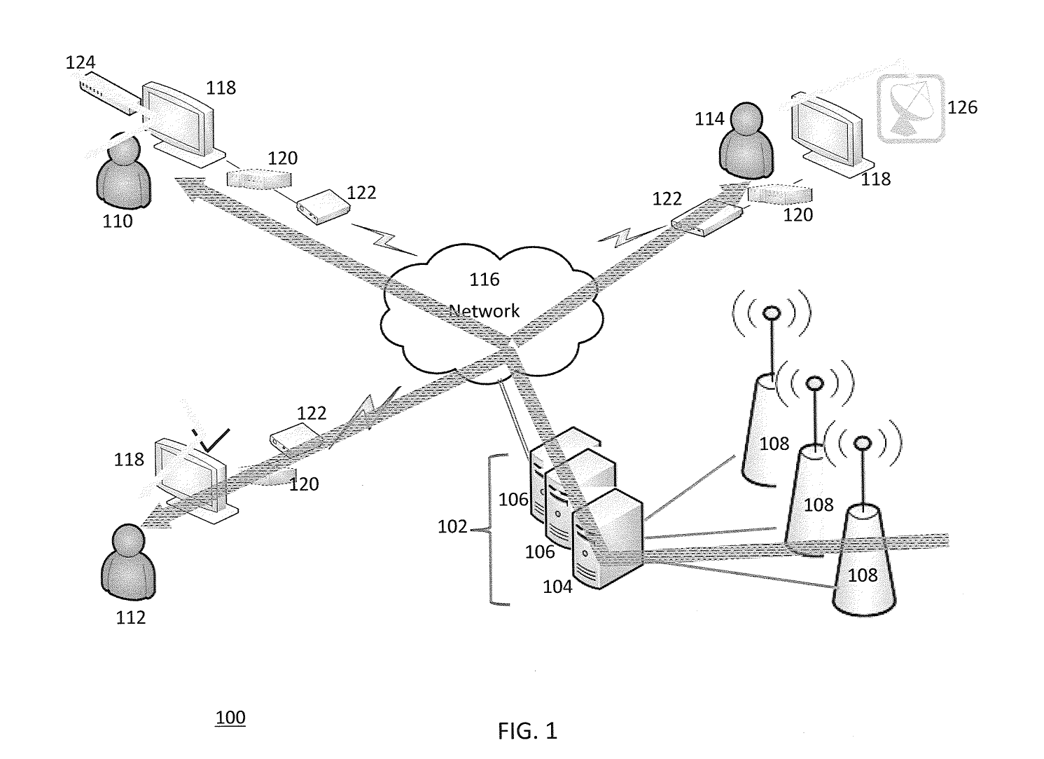

FIG. 1 is a diagram illustrating a system 100 for a relay and display of a channel based on a social network. The channel is a television channel. While the channel is described as a television channel, other channels are possible, such as a movie, an internet channel, a radio channel, a multimedia channel, and other channels. The social network is a network of contacts (also referred to as connections, friends, associates, colleagues, followers, mentors, mentees, and/or the like) connected on a social networking application executed over a communication network, such as internet, local area network, wide area network, metropolitan area network, or any other network.

One or more server computers 102 are implemented at a server station. The server computers 102 include a content server 104 and a management system 106. The content server 104 can include one or more computers, and the management system can include one or more computers. The content server 104 receives content of a channel from a third party, such as a business entity that desires to distribute its channel. The content of the channel can be received at base stations 108 via a direct connection, such as via ethernet, serial digital interface (SDI), asynchronous serial interface (ASI), high definition multimedia interface (HDMI) or other connections. In other implementations, the content of the channel can be received at base stations 108 via a communication network, such as a satellite downlink, internet, intranet, local area network, wide area network, Bluetooth network, infrared network, or any other network.

The content server 106 transmits and provides the content of the channel to subscribers 110 and 112. The content server 106 relays the content of the channel to a non-subscriber 114 if the non-subscribers is a contact of at least one subscriber 110 or 112 on a social network, wherein such a relay occurs for only a time-period for which the connected subscriber 110 or 112 is viewing (also referred to as accessing or watching) the channel. The social network is created and managed by the management system 106, wherein the users (for example, the subscribers 110 and 112, and the non-subscriber 114) can add and delete their respective social network contacts. Although the social network is described to be created and managed by the management server 106, other implementations using a third party social network are also possible, wherein the third party social network can be one of FACEBOOK, LINKEDIN, TWITTER, GOOGLE PLUS, or any other social network. The content of the television channel can be transmitted to the subscribers and associated non-subscribers over a communication network 116, such as the internet. Although internet has been described, other communication networks can also be used, such as intranet, local area network, wide area network, Bluetooth network, infrared network, or any other network.

For the transmission and relay of the content to users, which include the subscribers 110 and 112, and the non-subscriber 114, a user device 118 is implemented at a location of each user (110, 112, 114). For example, the user device 118 can be placed at a home of each user (110, 112, 114). The user device 118 includes a graphical user interface that displays a channel to the user (110, 112, 114), and an input device (for example, a remote control device with a keypad for input) that receives input data from the user (110, 112, 114). The user device 118 can be a television set, such as a smart television set. Although a television set is described, other user devices can alternately be implemented, such as a computer, a tablet computer, and other devices that have display capabilities. Each user device 118 is connected, via a wire or wirelessly, and with or without a set top box 120. If a set top box is employed, the set top box 120 can be placed next to the user device 118 in the home of the user (110, 112, or 114). The set top box 120 is connected, either via a wire or wirelessly, with an internet modem 122 that enables communication between a corresponding user (110, 112, or 114) and the servers 102.

The horizontal length (that is, the width) of the user device 118 can be more—and in some implementations, significantly more—than the vertical length (that is, the height) of the user device 118 so that the user device 118 allows a user (110, 112, 114) to easily navigate (for example, scroll) between various data elements, such as icons for channels, icons for contacts, and other data elements. Arranging of data elements in a horizontal fashion for horizontal navigation can be more aesthetically pleasing for a user (110, 112, or 114) than vertical scrolling, because such a horizontal arrangement can display more data without requiring the user (110, 112, and 114) to continue scrolling to view additional data.

Although a set top box 120 is described herein, in some other implementations, a set top box may not be required. For example, there can be an end-user software application that can be executed on a user device (for example, a smart television) that can provide functionality in lieu of the physical set top box 120.

While the user device 118 is connected to the set top box 120 and the internet modem 122, additionally, the user device 118 can optionally be connected to a cable television box 124. In another implementation, the user device 118 can optionally be connected to one of: an internet protocol television (IPTV) box, a receiver (for example, a satellite or any other receiver), and a tuner that allows the user (110, 112, and/or 114) to view the displayed content. Such a connection to the cable television box (or other receivers, as noted) allows the user (110, 112, and/or 114) to view cable television (or internet protocol television or other data) as well besides viewing the content of the channel transmitted by the servers 102. Further, the user device 118 can optionally be connected to a satellite system 126 including a satellite transceiver so that the user (110, 112, and/or 114) can view satellite television as well besides viewing the content of the channel transmitted by the servers 102.

As noted above, a channel is displayed to direct or first level contacts (for example, friends) of a subscriber on the social network when the subscriber is viewing the channel. However, other implementations are also possible. For example, in one implementation, the channel can be relayed and displayed to the first level contacts and the second level contacts (for example, friends of friends) of the subscriber on the social network when the subscriber is viewing the channel. In other implementations, the channel can be relayed and displayed to the first level contacts, the second level contacts, and the third level contacts of the subscriber on the social network when the subscriber is viewing the channel. In yet another implementation, the channel can be displayed to the contacts until any level of the subscriber, as determined by a developer of a client software application 302 (described below) implemented on the set top box 120, when the subscriber is viewing the channel.

The graphical user interface of the user device 118 displays data arranged according to an aesthetic display design 1402 (described below) that can appeal to the users (110, 112, and 114) and encourage them to view the channels displayed on the user device 118. If user device 118 is a TV set, the graphical user interface presents/displays the data with adequately large formats so that users (110, 112, and 114) can view the data from up to a preset distance (for example, 10 feet) from the user device 118 without much strain on their eyes. Further, the graphical user interface presents data with sufficient space between different data elements (for example, text elements and graphical elements) to avoid cluttering of those data elements on the graphical user interface.

Further, the graphical user interface of the user device 118 displays textual data using various fonts that the user (110, 112, and 114) can easily read from a distance, such as san seris fonts. Moreover, this textual data can have a dark color that allows the user (110, 112, and 114) to see the textual data from a distance. Additionally, the textual data can be presented in lines or paragraphs that are short (for example, maximum of 90 words) in order to encourage the user (110, 112, and 114) to read the textual data. To further encourage participation and interest of the user (110, 112, and 114), each line of the textual data has an average length of about 5-7 words, while having a minimum length of about 3 words and a maximum length of about 12 words. In some implementations, the graphical user interface can display a light colored text over a dark background rather than a dark colored text over a light background when possible. Within the textual data, there can be an extra spacing between sentences and between paragraphs. The graphical data displayed by the user device 118 can have varying contrast and saturation levels. To avoid vibrancy and ghosting effects on the graphical user interface of the user device 118, the graphical user interface may display pure white color sparingly. For example, if a displayed channel includes a section with a pure white color (for example, #FFFFFF), image processing techniques can be used to detect this section and replace the pure white color (for example, #FFFFFF) with a slightly different color (for example, #F1F1F1). Although pure white color has been described as being replaced by slightly different colors, in other implementations, other colors can also be replaced, such as bright red, bright orange, pure black, and/or any other color. Additionally, the graphical user interface can use more image processing techniques to minimize large differences (for example, gradients) spanning between colors of various displayed elements.

The user device 118 can include an input device, such as a remote control device, as mentioned above. The remote control device can be attached to a piece of furniture of the user (110, 112, and/or 114), such as a chair, a couch, a sofa, a table, a stand, and/or other pieces of furniture. The remote control device can include a keyboard for cursor movements. A mouse or a similar control device can be embedded on the remote control device. This mouse or similar control device allows the user (110, 112, and/or 114) to perform complex and precise movements on the graphical user interface of the user device 118. Such movements on the graphical user interface of the user device 118 include: drag and drop actions and drop down menu selections. Further, a directional pad—also be referred to as a D-pad or control pad—can be embedded on the remote control device. The directional pad allows the user (110, 112, and/or 114) to navigate in (for example, scroll through) various options, select items, and perform other functions. When the user (110, 112, and/or 114) uses the directional pad, the graphical user interface of the user device 118 can clearly highlight the active item that is being pointed to by a cursor that can be controlled by the directional pad.

The functionalities of various buttons on the directional pad embedded in the remote control device of the user device 118 can vary based on previous use of the remote control device by the user (110, 112, and/or 114). For example, if the user (110, 112, and/or 114) that is being displayed a first page opens a new page, a press/click by the user (110, 112, and/or 114) of the left button on the directional pad can cause the graphical user interface of the display device 118 to display the first page. At other times, the left button can be used to scroll to items on the left of a currently selected item.

Further, the user input device (for example, remote control device) of the user device 118 includes one or more gyroscopic sensors to measure orientation of the user input device. The gyroscopic sensors enable the user (110, 112, and/or 114) to draw figures on a graphical user interface displayed on the user device 118. The graphical user interface then allows the user to share the drawn figure with contacts or other users such that the graphical user interface displayed to those contacts or other users displays the shared figure.

Furthermore, the user input device (for example, remote control device) of the user device 118 includes at least one accelerometer to detect acceleration movements (for example, shakes) of the user input device. When the user performs a shaking acceleration movement with the user input device, the user device 118 of the user (110, 112, and/or 114) and the user devices 118 of the contacts or other users may vibrate. The vibration of each user device 118 can be accompanied with other multimedia effects, such as surround sound effects.

In some implementations, the user device 118 either includes (for example, embeds) or is connected to one or more cameras. One example of such a camera can be a web camera. These one or more cameras can allow video-conferencing between two or more users (110, 112, and/or 114).

The user device 118 supports one or more of at least the following standards: 1080p over high definition multimedia interface (HDMI), 720p over HDMI, 480p over HDMI, and other standards. The video described herein can have one or more of at least the following formats: 3GP, AVI, MP4, H.264, MKV, WMV, and any other suitable formats. The audio described herein can have one or more of at least the following formats: AAC, MP3, WAV, and any other suitable formats. The images described herein can have one or more of at least the following formats: JPG, PNG, and any other suitable formats.

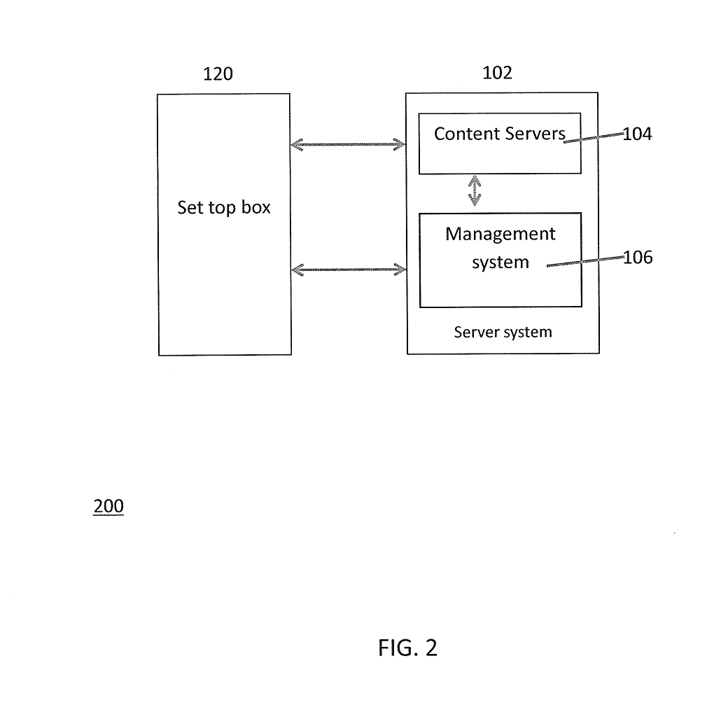

FIG. 2 is a system diagram illustrating a system 200 for a relay and display of a channel based on a social network. The set top box 120 is implemented at a location of a user, which can be either a subscriber 110, 112 or a non-subscriber 114. The set top box 120 receives content of the channel transmitted from content server 104, and displays the transmitted content to the user (110, 112, and/or 114). The set top box 120 stores, in a memory, the content of the channel for replaying and rewinding when the user (110, 112, and/or 114) desires. The set top box 120 also receives authentication data from the user (110, 112, and/or 114), wherein the authentication data can include login information, such as a user name and password, and/or other digital rights access authorization. For a user (110, 112, and/or 114) that has provided accurate authentication data, the set top box 120 determines a presence status of the user (110, 112, and/or 114) based on an access of the channel by the user (110, 112, and/or 114), a subscription status characterizing whether the user (110, 112, and/or 114) is a subscriber, and a social network characterizing one or more social networking contacts of the user (110, 112, and/or 114). Alternatively, the function of the set top box 120 can be implemented completely with a software application that is executed on a browser or on any other device.

The management system 106 receives the authentication data from the set top box 120 and validates the user (110, 112, and/or 114) based on the authentication data. For a validated user (110, 112, and/or 114), the management system 106 receives the presence status from the set top box 120 via the communication network 116. The management system 106 retrieves the subscription status and the social network from a database within the management system 106, wherein this database stores the subscription status and the social network of the user (110, 112, and/or 114).

Based on the presence status, the subscription status, and the social network, as received at the management system 106, the content server 104 can transmit content of the television channel to the set top box 120. The transmitted content is then displayed to the user (110, 112, and/or 114) on a graphical user interface of the user device 118.

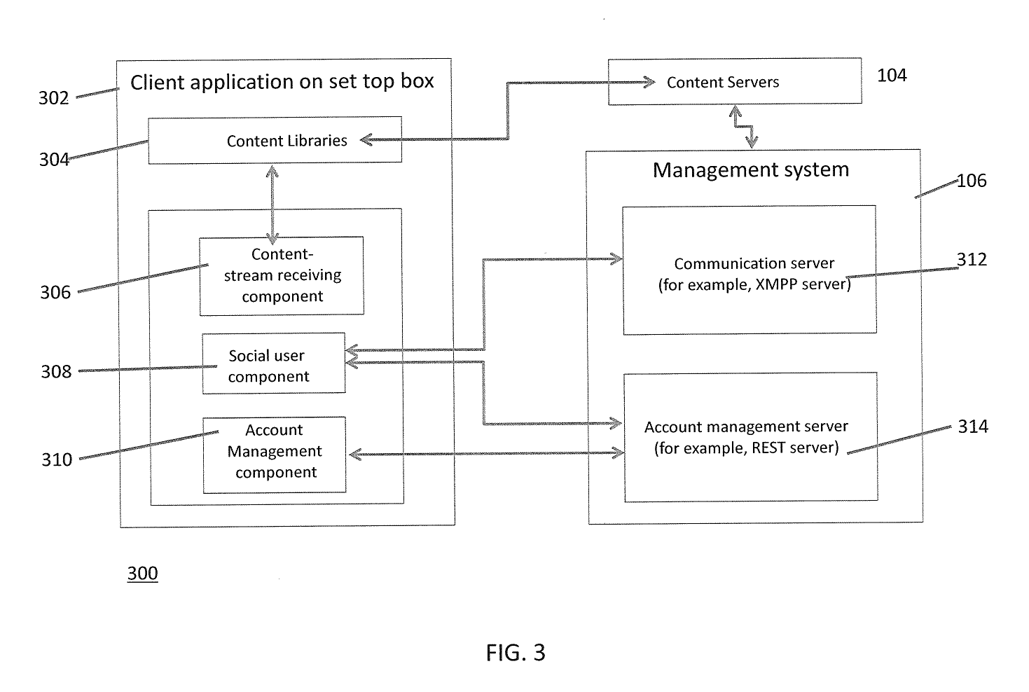

FIG. 3 is a system diagram illustrating a system 300 for a relay and display of a channel based on a social network. A set top box 120 is implemented at a location of a user (110, 112, and/or 114), such as a home or office of the user (110, 112, and/or 114). The set top box 120 implements a client software application 302 including one or more content libraries 304 (also referred to as content access provider libraries), a content-stream receiving component 306, a social user component 308, and an account management component 310. The content-stream receiving component 306 receives the content from the content libraries 304 so that the content can be transmitted and provided when the user (110, 112, and/or 114) or a developer of the software application 302 desires. The social user component 308 determines a presence status of the user (110, 112, and/or 114) based on a viewing activity of the channel by the user (110, 112, and/or 114). The social user component 308 determines a subscription status characterizing whether the user (110, 112, and/or 114) is a subscriber, and a social network characterizing one or more social networking contacts of the user (110, 112, and/or 114). The account management component 310 receives authentication data from the user (110, 112, and/or 114), such as login data including a username and a password.

The management system 106 includes a communication server 312 and an account management server 314. The communication server 312 uses an extensible messaging and presence protocol (XMPP) while communicating with the social user component 308. The account management server 314 implements a representational state transfer (REST) software architecture that uses a hypertext transfer protocol secure (HTTPS) protocol. The communication server 312 receives the presence status from the social user component 308. The account management server 314 stores the social network characterizing one or more social networking contacts of the user (110, 112, and/or 114), provides the information associated with the social network to the social user component 308, and receives the authentication data from the account management component 310. In some other implementations, the communication server 312 can be implemented using architecture other than REST, and/or the account management server 314 can be implemented using architecture other than HTTPS.

The content servers 104 transmit content of the television channel to the one or more content libraries 304 based on the authentication data, the presence status, the subscription status, and the social network. The transmitted content of the television channel is then displayed to the user (110, 112, and/or 114) on a graphical user interface of the user device 118.

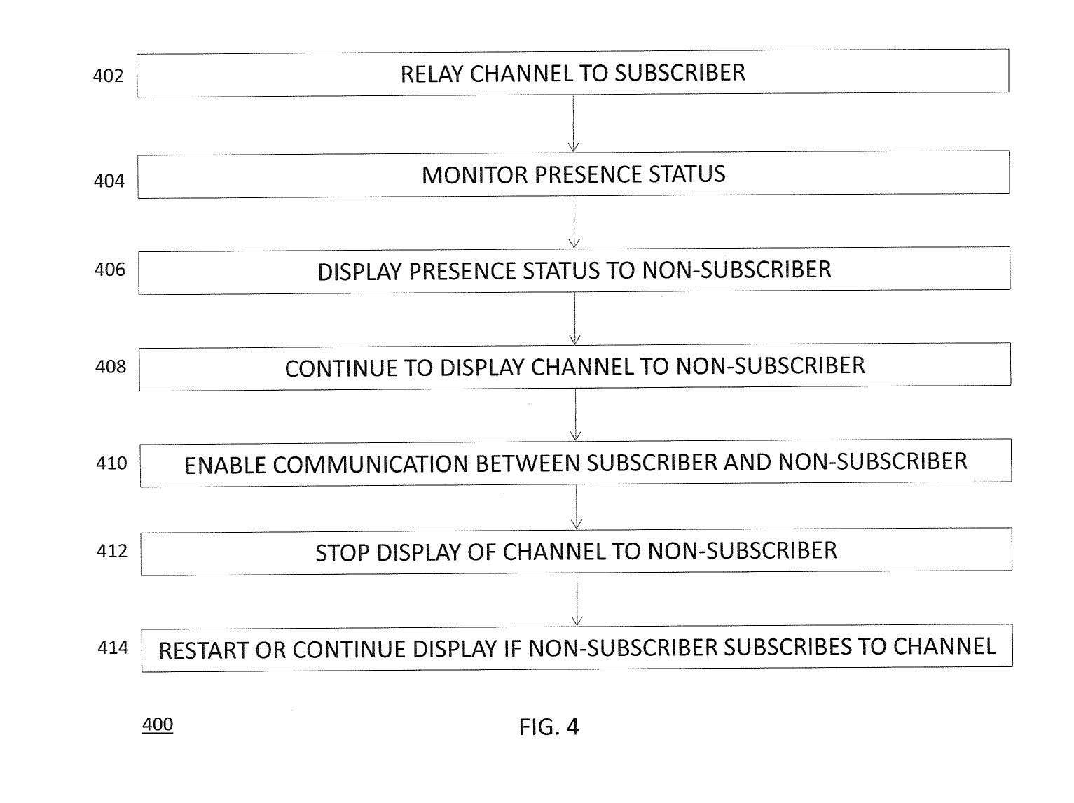

FIG. 4 is a flow diagram illustrating a method 400 of relaying and displaying a channel to a non-subscriber when a subscriber is viewing the channel. At 402, the content provider server 104 transmits a channel to a subscriber (110 or 112) of a service offering the channel. The channel can be transmitted over a communication network 116, such as the internet. The transmitted channel can be displayed to the subscriber (110 or 112) on a graphical user interface of the user device 118 of the subscriber (110 or 112).

At 404, the social user component 308 of the software application 302 monitors a presence status of the subscriber. The presence status characterizes a presence of the subscriber 110 or 112 for viewing the television channel. The presence status characterizes at least one of the following activities of the user (110, 112, and/or 114): viewing the channel, not viewing the channel for less than a threshold value of time, not viewing the channel for more than the threshold value of time, and viewing another television channel.

At 406, the presence status is displayed to the contacts of the subscriber, who may be either subscribers or non-subscribers of the channel that is being viewed by the subscriber. Thus, if the non-subscriber 114 is a contact of the subscriber, the presence status is displayed to the non-subscriber. For any user (110, 112, and/or 114), the presence status of all contacts of the user (110, 112, and/or 114) is displayed to the user (110, 112, and/or 114). With respect to diagram 400, the non-subscriber 114 is assumed to be a contact of the subscriber 110 or 112, and the presence status is displayed on a graphical user interface of the user device 118 of the non-subscriber 114.

The television channel can be displayed to any user (110, 112, and/or 114), irrespective of the subscription status of the user (110, 112, and/or 114), for a first predetermined period of time (for example, 10 seconds, 30 seconds, 1 minute, 2 minutes, or any other period of time). After the predetermined period elapses, the transmission and display of the television channel to a non-subscriber can continue only if either a contact of the non-subscriber is a subscriber and is viewing the television channel. At 408, at the first predetermined period of time and when the management system 106 verifies from the presence status that the subscriber is viewing the television channel, the content provider server 104 continues to transmit the channel to the non-subscriber 114 via the communication network 116, such as the internet. The transmitted channel can be displayed to the non-subscriber 114 on a graphical user interface of the user device 118 of the non-subscriber 114.

The subscriber and the one or more non-subscribers are displayed a same content of the channel at all times such that there is no or minimal lag/delay between the displays to different users (110, 112, and/or 114). For example, when different users (110, 112, and/or 114) are viewing a soccer match, different kicks by players, running movements of the players, goals scored by the players, and all other events in the soccer match are simultaneously displayed with no lag or a minimal lag to all the users (110, 112, and/or 114). The display of the channel with no or minimal delay is accomplished as follows. The client application 302 of the non-subscriber calculates the delay, and informs about this delay to the content libraries 304 and content stream receiving component 306. The content libraries 304 compensate for the delay so that the channel is displayed synchronously to the subscriber (110 or 112) and the non-subscriber 114.

At 410, communication can be enabled between the subscriber 110 or 112 and the non-subscriber 114 when the television channel is being displayed to the subscriber 112 and the non-subscriber 114. This communication can be one or more of text, voice, video or multimedia communication, as desired by either the subscriber (110 or 112) or the non-subscriber 114.

At 412, the transmission and display of the television channel to the non-subscriber 114 can be stopped at and after a second predetermined period of time (for example, 2 minutes, 5 minutes, 15 minutes, 30 minutes, or any other period of time) passes after the first predetermined time irrespective of whether the non-subscriber 114 is a contact of the subscriber (110 or 112). The server system 102 can stop the transmission and display of the television channel to the non-subscriber 114 when the non-subscriber 114 stops watching the television channel. In another implementation, the server system 102 can stop the transmission and display of the television channel to the non-subscriber 114 when the subscriber (110 or 112) switches to another television channel or turns off the system (for example, turns off his/her set top box). At the second predetermined period of time, the non-subscriber 114 is provided an option to subscribe by performing an action, such as paying, using a coupon, obtaining a credit, or any other suitable action.

At 414, the transmission and display of the television channel to the non-subscriber is continued or restarted if the non-subscriber 114 subscribes to the television channel.

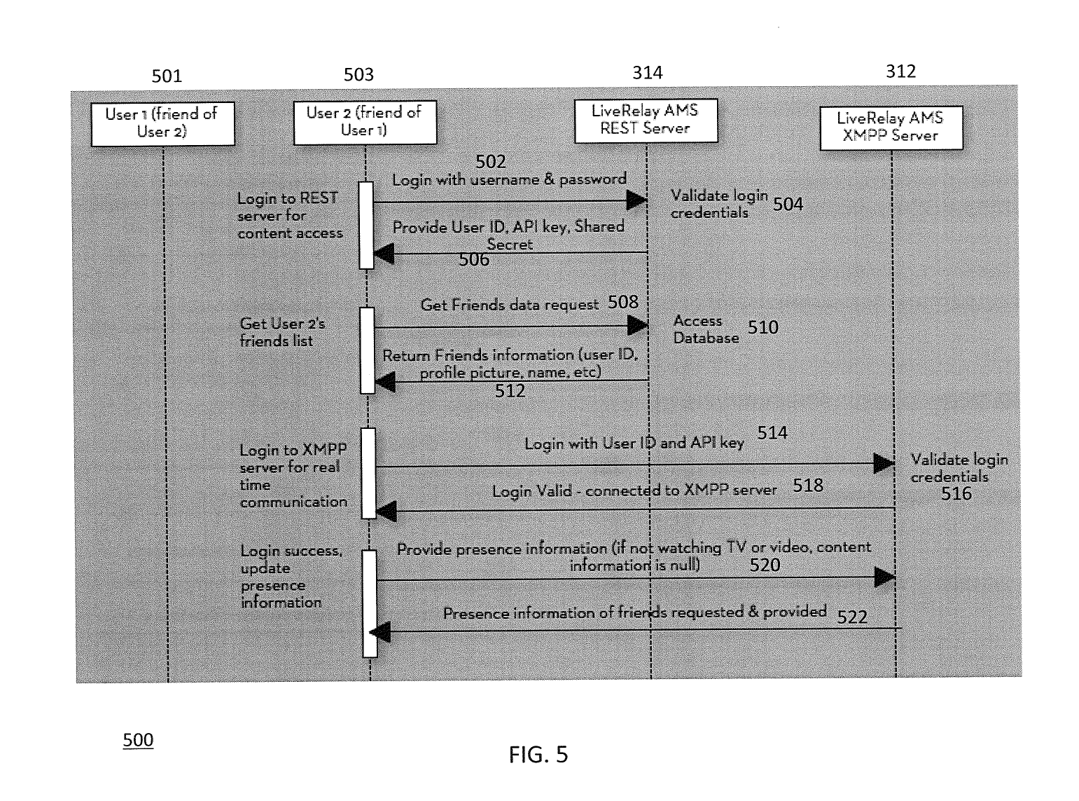

FIG. 5 is a flow diagram 500 illustrating a first sequence of steps performed to simultaneously display the channel to different users (110, 112, and/or 114) and allow a communication between those users (110, 112, and/or 114). The flow diagrams 500, 600 (described below), 700 (described below) and 800 (described below) collectively show a method of simultaneously displaying the channel to a first user 501 and a second user 503 that is a contact of the first user 501 on the social network, and allowing a communication between the first user 501 and the second user 503.

At 502, the second user 503 logs-in by inputting a username and password on a graphical user interface of the user device 118 of the second user 503. This inputted username and password are sent over the communication network 116 to the account management server 314.

At 504, the account management server 314 validates the username and password of the second user 503.

At 506, if the username and password are determined as valid by the account management server 314, the account management server 314 sends a user identifier, an application programming interface key, and a shared secret key to the client application on the set top box 302 of the second user 503. The shared secret key facilitates identification and authentication of exchange between any of the users (501, 503) and the account management server 314. The shared secret key is generated after initial exchange and is used for encryption and de-encryption during subsequent exchanges in order to ensure that communications is secure. The user identifier and the application programming interface key can be used by the client application 302 of the second user 503 to communicate with 314 to gain access and view any channel desired by the second user 503 if the second user 503 is a subscriber of a service offering various channels. If the second user 503 is not a subscriber, the channel can be displayed to the second user 503 only if a contact of the second user 503 on the social network is a subscriber and is viewing the channel.

At 508, the second user 503 requests to view information associated with contacts of the second user 503 on the social network. The contacts can be one or more of: first level contacts, second level contacts, third level contacts, and so on.

At 510, the account management server 314 accesses an associated database to find the contacts of the second user 503. The associated database can be a memory within the account management server 314 such that the access of the database is local. In other implementations, the database can be remote to the account management server 314, and the database can be accessed remotely over a network, such as a local area network, wide area network, internet, or the like.

At 512, the account management server 314 provides a list or tree of social network contacts of the second user 503 to the client application 302 of the second user 503. For example, the account management server 314 sends data associated with the contacts of the second user 503, wherein this data includes a user identifier, profile photograph, name, and any other identifier associated with each contact of the second user 503.

At 514, the second user 503 logs-in to the communication server 312 by inputting, in the client application 302, the user identifier and the application programming interface key.

At 516, the communication server 312 validates the user identifier and the application programming interface key.

At 518, if the user identifier and the application programming interface key are valid, the second user 503 is connected to the communication server 312, and the communication server 312 sends a confirmation of this connection. When both the second user 503 and first user 501 are connected to the communication server 312 and are viewing the same channel, they can communicate with each other. This communication can be one or more of text, voice, and video communication, as desired by either the second user 503 or the first user 501. The text communication can include emoticons, tweets, predefined text such as canned text, third party messages such as TWITTER messages, and other possible text communication. The voice communication can include speech, laughter, utterances, hisses, boo's, shouts, and other audio signals other than noise. The video communication can include significant movements of the users 501 and 503, such as a jumping movement when a home-run is scored in a baseball match.

A set top box 120 implemented at a location of the second user 503 automatically obtains the second user 503's presence status (for example, status indicating whether the second user 503 is viewing a channel), and indications of whether the second user 503 is scrolling from channel to channel, powered on the device, is powered off the display device, and/or is on a particular menu screen. The presence status is obtained based on current activities of the second user 503. The presence status can be updated with a click on the channel change button on the remote to change the channel. The presence status characterizes at least one of the following activities associated with the second user 503: viewing the television channel, not viewing the channel for less than a threshold value of time, not viewing the channel for more than the threshold value of time, and viewing another television channel.

At 520, the obtained presence is then sent to the communication server 312 via the communication network 116. The presence status of the second user 503 is used to display to the contacts of the second user 503 irrespective of whether the second user 503 is being displayed the channel. In some implementations, the presence status is updated in real-time and displayed in real-time. In other implementations, the presence status can be updated at regular intervals of time, such as every 30 seconds, 1 minute, 2 minutes, 5 minutes, 30 minutes, 1 hour, 2 hours, or any other value of time. In yet other implementations, the presence status can be updated based on an event, such as a click of a button on a remote control device provided to the second user 503.

In some implementations, the first user 501 can be a non-subscriber 114, and the second user 503 can be a subscriber 110 of a service offering the channels. In these implementations, if the second user 503's presence status indicates that the second user 503 is viewing a specific channel for more than a threshold value of time (that is, not channel browsing but watching a particular channel steadily), the channel can be displayed to the contacts of the second user 503. Otherwise, the specific channel that second user 503 is watching is prevented from being displayed to the other users.

At 522, the communication server 312 can send a presence status of social network contacts of the second user 503 along with identifications of the contacts. For example, the communication server 312 sends and displays the presence status of another user who is already watching a particular channel to the second user 503. If that another user is viewing the channel, the second user 503 can decide whether to view the channel along with this another user and/or to communicate with this another user.

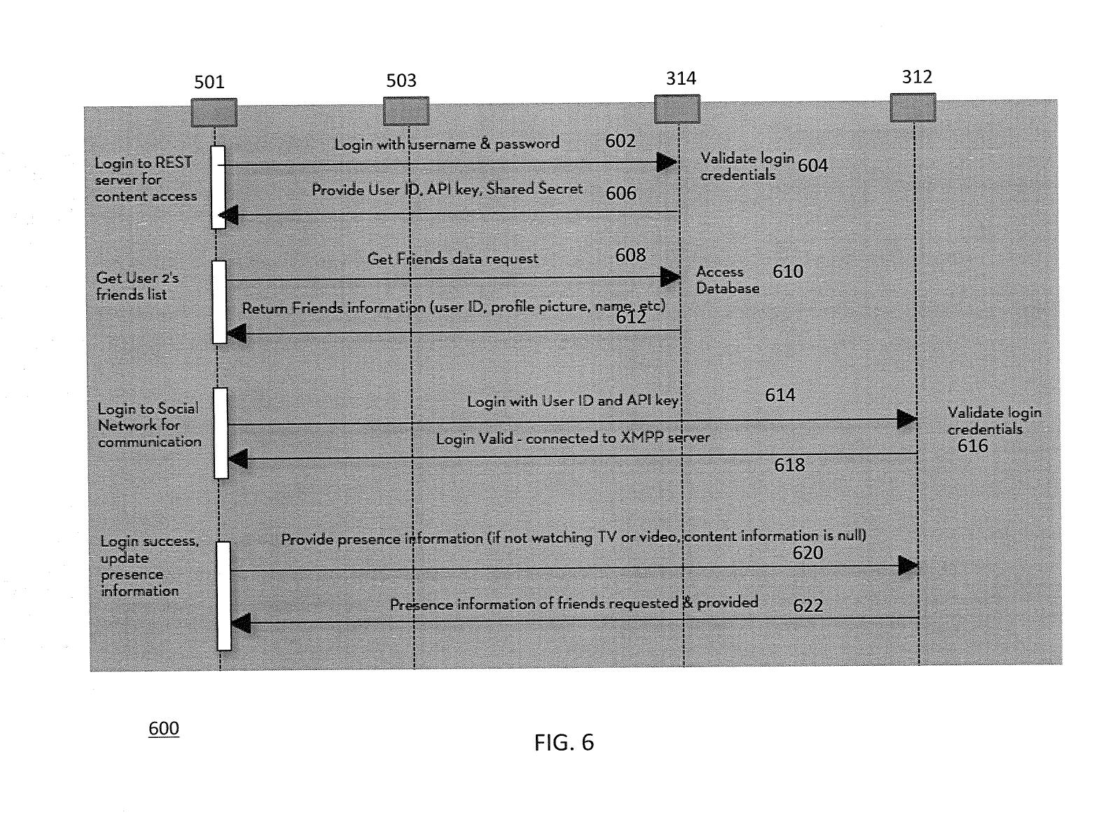

FIG. 6 is a flow diagram 600 illustrating a second sequence of steps performed to simultaneously display the channel to different users (501, 503) and allow a communication between those users (501, 503). The flow diagrams 500, 600, 700 (described below) and 800 (described below) collectively show a method of simultaneously displaying the channel to different users and allowing a communication between those users (501, 503).

At 602, the first user 501 logs-in by inputting a username and password on a graphical user interface of the user device 118 of the first user 501. This inputted username and password are sent over the communication network 116 to the account management server 314. At 604, the account management server 314 validates the username and password of the first user 501.

At 606, if the username and password of the first user 501 are determined as valid by the account management server 314, the account management server 314 sends a user identifier, an application programming interface key, and a shared secret key to the client application 302 of the first user 501. The client application 302 of the first user 501 can use the user identifier and the application programming interface key to communicate with the account management server 314 to gain access to and view a channel desired by the first user 501. If the first user 501 is a non-subscriber 114 and the second user 503 is a subscriber 110, the first user 501 can view a particular channel only if the second user 503 is also already and viewing the particular channel. The shared secret key can facilitates identification and authentication of exchange between any of the users (501, 503) and the account management system. The shared secret key can be generated after initial exchange and can be used for encryption and de-encryption during subsequent exchanges in order to ensure that communications is secure.

At 608, the first user 501 requests to view information associated with contacts of the first user 501 on the social network. The contacts can be one or more of: first level contacts, second level contacts, third level contacts, and so on.

At 610, the account management server 314 accesses an associated database to find the contacts of the first user 501. The associated database can be a memory within the account management server 314 such that the access of the database is local. In other implementations, the database can be remote to the account management server 314, and the database can be accessed remotely over a network, such as a local area network, wide area network, internet, or the like.

At 612, the account management server 314 provides a list or tree of contacts of the first user 501 to the first user 501. For example, the account management server 314 sends data associated with the contacts of the first user 501, wherein this data includes a user identifier, profile photograph, name, and any other identifier associated with each contact of the first user 501.

At 614, the first user 501 logs-in to the communication server 312 by inputting the user identifier and the application programming interface key, as received by the user at 606, in the client application 302. At 616, the communication server 312 validates the user identifier and the application programming interface key.

At 618, if the user identifier and the application programming interface key are valid, the first user 501 is connected to the communication server 312, and the communication server 312 sends a confirmation of this connection. When both the first user 501 and the second user 503 are connected to the communication server 312 and are viewing the same channel, they can communicate with each other. This communication can be one or more of text communication, voice communication, and video communication, as desired by either the first user 501 or the second user 503.

A set top box 120 implemented at a location of the first user 501 automatically obtains the first user 501's presence status on a channel. The presence status is obtained based on activities of the first user 501, such as a click on the channel change button on the remote to change the channel. The presence status characterizes at least one of the following activities associated with the first user 501: viewing the television channel, not viewing the channel for less than a threshold value of time, not viewing the channel for more than the threshold value of time, and viewing another television channel.

At 620, the obtained presence is then sent to the communication server 312 via the communication network 116. The presence status of the first user 501 viewing a channel is then displayed and notified to the second user 503. In some implementations, the presence status is updated in real-time and displayed in real-time. In other implementations, the presence status can be updated at regular intervals of time, such as every 30 seconds, 1 minute, 2 minutes, 5 minutes, 30 minutes, 1 hour, 2 hours, or any other value of time.

At 622, the communication server 312 can send a presence status of social network contacts of the first user 501 along with identifications of the contacts. For example, the communication server 312 sends and displays the presence status of the second user 503 for a particular channel to the first user 501. If the second user 503 is viewing a particular channel, the first user 501 can decide whether to view the particular channel along with the second user 503 and/or whether to communicate with the second user 503.

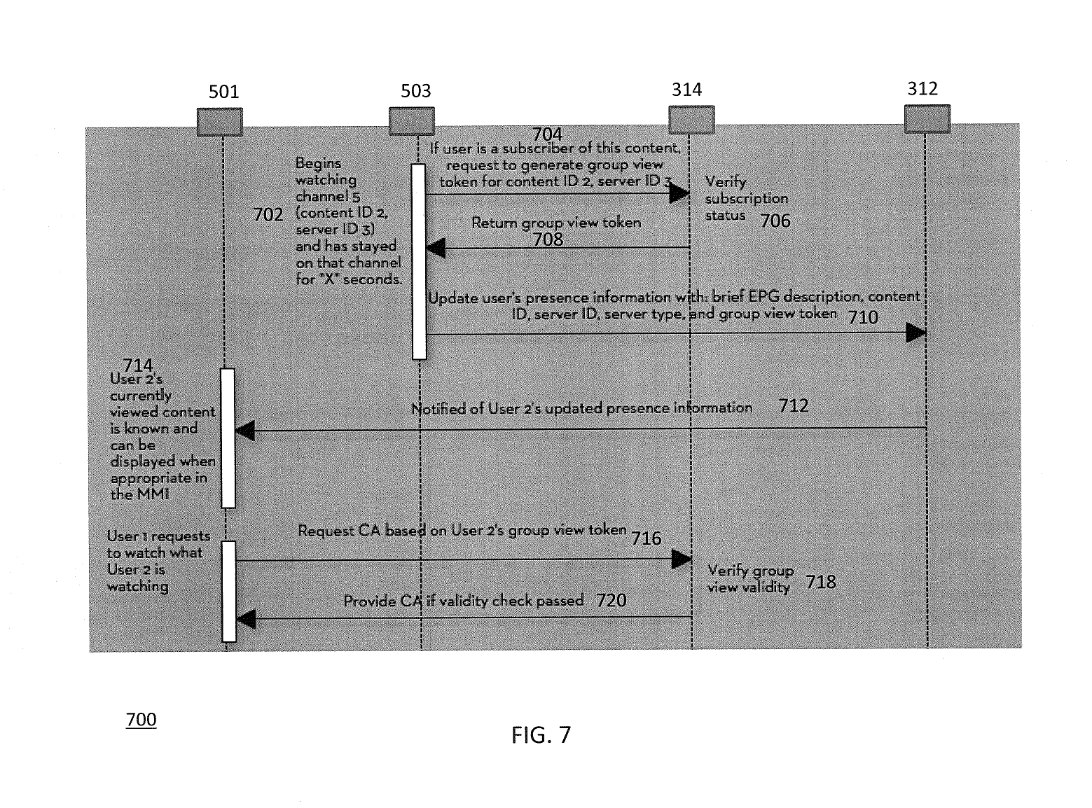

FIG. 7 is a flow diagram 700 illustrating a third sequence of steps performed to simultaneously display the channel to different users (501, 503) and allow a communication between those users (501, 503). The flow diagrams 500, 600, 700 and 800 (described below) collectively show a method of simultaneously displaying the channel to different users (501, 503) and allowing a communication between those users (501, 503).

At 702, the second user 503 begins viewing a channel, and continues to view for more than a threshold amount of time (for example, 1 second, 2 seconds, 5 seconds, 20 seconds, 40 seconds, 1 minute, 5 minutes, 30 minutes, or any other amount of time specified by the service provider that offers the channel).

At 704, if the second user 503 is a subscriber of a service offering multiple channels including the channel viewed by the second user 503, the client application of the subscriber sends a request to generate a first group view token to the account management server 314. The group view token includes: identification of the subscriber for whom the group view token is generated, the channel, a number of consumers (for example, contacts of the subscriber) that are allowed to concurrently use the group view token, and a number of consumers for which the group view token is currently activated. In one variation, the group view token can include a server identifier that indicates the location of the server that has stored the content of the channel.

For a consumer to access channel for which the consumer is not subscribed, the following occur. The account management server 314 has a prior knowledge of the group view token associated with the channel that the consumer desires to view. The consumer requests accessing the channel. Subsequently, the client application 302 of the consumer sends a request to the account management server 314. In return, the account management server 314 validates the request by verifying that limits have not been exceeded, that the group view token is still valid, by checking friends relationship, and performing other checks. If the token validation succeeds, the group view token can be delivered to the consumer either through the communication server 312 or through the account management server 314. Along with the group view token, the server can provide playback information (for example, instructions to use the group view token) that the consumer can use to view the content.

At 706, the account management server 314 verifies the subscription status of the second user 503 so as to determine whether the second user 503 is a subscriber. At 708, upon verifying that the second user 503 is a subscriber, the account management server 314 generates and sends a first group view token to the second user 503.

A set top box 120 implemented at a location of the second user 503 automatically obtains the second user 503's presence status on a channel. The presence status is obtained based on activities of the second user 503, such as a click on the channel change button on the remote to change the channel, and any other activity. The presence status characterizes at least one of the following activities associated with the second user 503: viewing the television channel, not viewing the channel for less than a threshold value of time, not viewing the channel for more than the threshold value of time, and viewing another television channel.

At 710, the set top box 120 of the second user 503 sends a presence data of the second user 503 updating the communication server 312 that the second user 503 is viewing a particular channel. The presence data is constantly updated. The updated presence data includes a brief electronic programming guide (EPG) description, the content identifier, the server identifier, and the first group view token.

At 712, the communication server 312 sends the updated presence data of the second user 503 to the first user 501.

At 714, the user device 118 of the first user 501 displays the presence data of the second user 503. If the presence data of the second user 503 indicates that the second user 503 is viewing the channel, the first user 501 can view the channel if the first user 501 is a contact of second user 503.

At 716, the first user 501 sends a request to the account management server 314 to view the channel that is being viewed by the second user 503. The request is based on the first group view token that was generated and sent to the second user at 708.

At 718, the account management server 314 can determine whether the first group view token of the second user 503 is valid for use by the first user 501. To determine the validity of the first group view token of the second user 503, it is determined whether the first user 501 is a contact to the second user 503 on the social network. If the first user 501 is directly connected to the second user 503 on the social network, the first group token is considered to be valid. Other conditions (for example, whether the limit of allowed concurrent views for this token has been reached) may also determine whether the token is considered to be valid.

At 720, the account management server 314 enables/allows the first user 501 to view the channel when the second user 503 is viewing the channel. When the first user 501 is enabled to view the channel, the one or more content provider servers 104 send the content of the channel on the user device 118 of the first user 501. A graphical interface of the user device 118 displays the content of the channel.

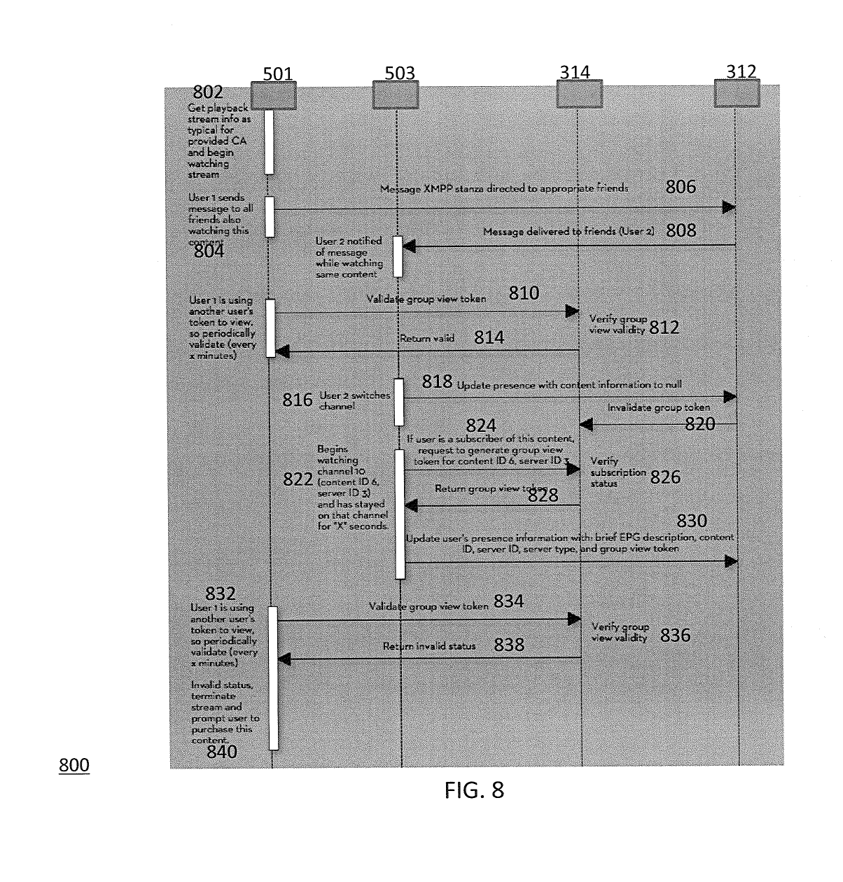

FIG. 8 is a flow diagram 800 illustrating a fourth sequence of steps performed to simultaneously display the channel to different users (501, 503) and allow a communication between those users (501, 503). The flow diagrams 500, 600, 700 and 800 collectively show a method of simultaneously displaying the channel to different users (501, 503) and allowing a communication between those users (501, 503).

At 802, the first user 501 receives the playback stream data for the channel from the content provider servers 104, and begins viewing the channel. At 804, the first user 501 enters a message for all contacts in the social network that are also viewing the channel. The message is entered on the graphical user interface of a user device 118 of the first user 501. The message can be entered using a remote control device provided with the set top box 120. Although a remote control device is described as an input device herein, other input devices can also be used, such as a keyboard, a mouse, a joystick, an audio microphone, and/or any other input device. The message can be short and can have an upper limit, such as 50 words, 75 words, 100 words, 120 words, 140 words, 200 words, or any other number.

At 806, the set top box 120 of the first user 501 sends the message to the communication server 312. At 808, the communication server 312 sends the message to all or any specific one of the contacts of the first user 501, including the second user 503 as selected by first user 501. At 810, the first user 501 sends a first group view token of the second user 503 to the account management server 314 so as to validate the first group view token for continuing to view the channel.

At 812, the account management server 314 verifies whether the first user 501 is connected to the second user 503 in the social network. If the first user 501 is connected to the second user 503 in the social network, the account management server 314 can enable the non-subscribing first user 501 to view the channel when the subscribing second user 502 views the channel.

At 814, the account management server 314 sends a confirmation message to the set top box 120 of the first user 501. The confirmation message characterizes that the subscribing second user 502 is viewing the channel and that the first user 501 is connected to the second user 502 on the social network. Subsequently, the set top box 120 facilitates a display of the channel on the graphical user interface of the user device 118 of the second user 502.

At 816, the subscribing second user 503 stops viewing the channel. The presence status of the second user 503 changes from viewing the channel to not viewing the channel. At 818, the updated presence status of the second user 503 is sent to the communication server 312. At 820, the communication server 312 sends a message to the account management server 314, the message requesting to invalidate the first group token associated with the channel.

In addition to the subscribed user leaving the current channel, there can be alternate or additional other cases of invalidation, such as one or more of: user logging out from the server, disconnection from the server due to network unavailability, a simultaneous login from another device, and any other feasible condition. Specifically, invalidation of a group view token can occur as a result of the subscriber logging out from the communication (XMPP) server, logging out of the account management server, being disconnected from the communication server (due to network connectivity interruption), logging into the XMPP server on the same account from another device, and/or any other condition.

At 822, the second user 503 begins viewing a second channel, and continues to view for more than a threshold amount of time (for example, 1 second, 2 seconds, 5 seconds, 20 seconds, 40 seconds, 1 minute, 5 minutes, 30 minutes, or any other amount of time specified by the service provider that offers the channel). The second channel is associated with a content identifier and a server identifier. The content identifier identifies the channel, and the server identifier identifies the location of the server that has stored the content.

At 824, the subscribing second user 503 sends a request to the account management server 314, the request requesting a second group view token to be generated for the second channel. At 826, the subscription status of the second user 503 is verified to determine that the second user 503 is subscribed to the service offering the second channel. At 828, the second group view token for the second channel and the second user 503 is generated and sent to the second user 503.

At 830, the set top box 120 of the second user 503 determines a presence status of the second user 503, and sends presence data to the communication server 312. The presence data is constantly updated. The updated presence data includes a brief electronic programming guide (EPG) description, the content identifier, the server identifier, and the second group view token.

At 832, the non-subscribing first user 501 continues to use the first (that is, old) group view token for the channel that was viewed by the second user 503 before viewing the second channel. At 834, the first user 501 sends a request to the account management server 314 to validate the first group view token for the first user 501. At 836, the account management server 314 verifies a validity of a group view. This validity is not verified, as the first group view token was invalidated, as noted above at 820.

The non-subscriber's video stream can be terminated by a group view token polling validation mechanism. In one implementation, the termination of the non-subscriber's video stream can be initiated by a server. This initiation by the server is not dependent upon the client device to periodically validate the token. In this method, the server may detect that a group view token has been invalidated and may directly terminate any video streams which were delivered as a result of the group view token.

At 838, the account management server 314 sends an invalid status to the first user 501. The invalid status characterizes that the first group view token is invalid and the first user 501 needs a new token to continue viewing the channel or needs to subscribe to the service so as to continue viewing the channel. At 840, the invalid status terminates the display of content of the channel to the first user 501, and displays a message to the first user 501. In another implementation, the termination of viewing (as described in the implementation of ‘invalid status’ above) can be implemented by a cease order given by the communication server 312 or the account management server 314 to the first user 501. The displayed message prompts the first user 501 to purchase the service from a store including multiple channels so as to continue viewing the channel.

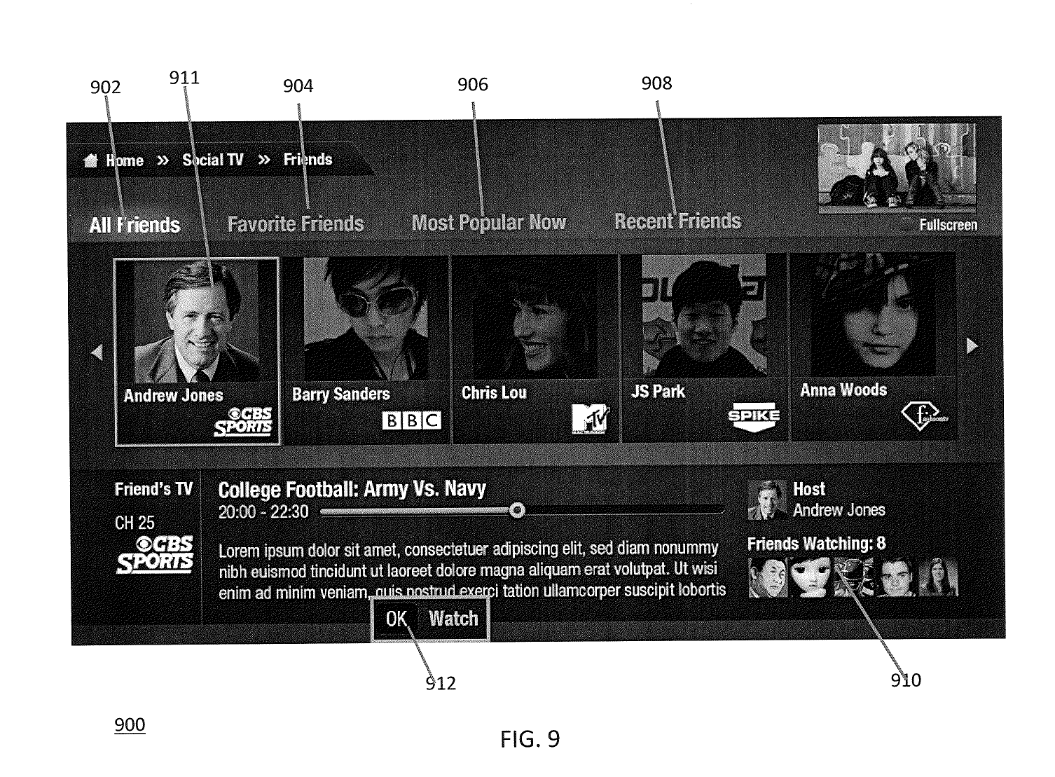

FIG. 9 is a diagram illustrating a first graphical user interface 900 that allows a group-watch of a channel by different users (110, 112, and/or 114) in a virtual living room. Group-watch characterizes a simultaneously view of a channel by different users (110, 112, and/or 114) in a group and an interaction between those users. Group-watch allows social network contacts to interact with each other conveniently and intuitively, as further explained below. Two or more users (110, 112, and/or 114) can interact with each other simultaneously, thereby forming a virtual living room where people can view a same channel and discuss about the viewed channel.

On the graphical user interface 900, icons of contacts of a user (110, 112, and/or 114) are displayed. When the user (110, 112, and/or 114) clicks on a contact's channel list (by scrolling at icons 1708, as described below), the user is immediately displayed the list of friends who are on the system and the respective electronic programming guide (EPG) of the channel being viewed by each contact. When the user (110, 112, and/or 114) clicks an “All Friends” button 902 on the graphical user interface 900, the graphical user interface 900 can display a list of contacts of the user (110, 112, and/or 114). Based on the selected criteria for display, the graphical user interface 900 can display the friends according to the selected criteria. When the user (110, 112, and/or 114) clicks the “Favorite Friends” button 904, the user (110, 112, and/or 114) can be enabled to create and/or access one or more favorite contacts. The user (110, 112, and/or 114) can be enabled to add or delete favorite contacts via the user device 118 or via a web computing application that the user (110, 112, and/or 114) can access either on the user device 118 or any other computing device. When the user (110, 112, and/or 114) clicks the “Recent Friends” button 908, the graphical user interface 900 can display the recent friends of the user.

The contacts of the user (110, 112, and/or 114) can be displayed based on criteria specified by the user (110, 112, and/or 114) for display of the contacts. The criteria for display can be one or more of: display of contacts sorted according to first name, display of contacts sorted according to last name, display of contacts sorted according to location, display of contacts sorted according to subscription status, display of contacts according to channels viewed by them, display according to frequency of channel views, frequency of views with each contact, time spent on the respective user device 118, and other criteria.

One or more of the buttons 902, 904, 906, and 908 can also be provided on a remote control device provided to the user (110, 112, and/or 114) along with the set top box 120. An icon of each contact can display at least some of: a name and photo (or other one or more identifiers) of the contact, the channel viewed by the contact, the program being viewed by the contact on the viewed channel, and the presence status of the contact for the channel. The user (110, 112, and/or 114) can select (by clicking) an icon of a contact with whom the user (110, 112, and/or 114) wants to simultaneously view the content being currently viewed by the contact, and then communicate (for example, text chat, talk, and/or video chat) in a separate menu interface. Also, when the user (110, 112, and/or 114) selects the icon of a contact, the portion 910 of the graphical user interface 900 can display a number of contacts that are viewing the channel together with the selected contact. For example, when the user (110, 112, and/or 114) selects the icon 911 for contact “Andrew Jones,” the portion 910 of the graphical user interface 900 displays the contacts of “Andrew Jones” that are viewing the channel together with “Andrew Jones.” After the user (110, 112, and/or 114) selects the icon 911, the user device 118 of the user (110, 112, and/or 114) can display the channel displayed to the contact “Andrew Jones.”

In another aspect, the user (110, 112, and/or 114) can select the icon of a contact, and then invite the contact to view the channel being displayed to the user (110, 112, and/or 114). If the invited contact decides to join, the user device 118 of the contact of the user (110, 112, and/or 114) can display the channel being displayed to the user (110, 112, and/or 114).

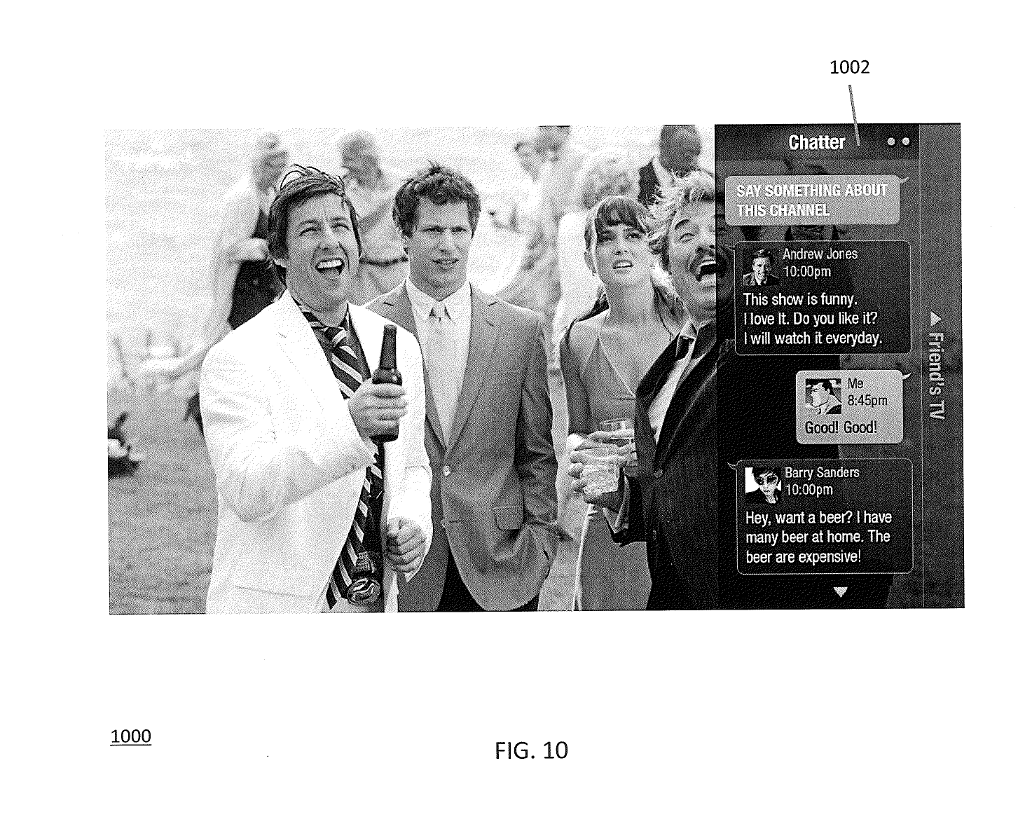

FIG. 10 is a diagram illustrating a second graphical user interface 1000 that allows group-watch of a channel by different users (110, 112, and/or 114) in a virtual living room. When an input of the user (110, 112, and/or 114) is pointing on the icon 911 for the contact “Andrew Jones,” the user (110, 112, and/or 114) is provided an OK button 912 (shown in diagram 900) that the user (110, 112, and/or 114) can click to view the channel viewed by the contact “Andrew Jones.” The channel viewed by the contact “Andrew Jones” can be displayed on the graphical user interface 1000. The graphical user interface 1000 displays a chat window 1002 that allows the user (110, 112, and/or 114) to chat with other contacts of the user (110, 112, and/or 114) that are viewing the selected channel that is being viewed by the contact “Andrew Jones.” The chat window 1002 can display a history of chat of a user (110, 112, and/or 114) with the contact “Andrew Jones” or with any other desired particular contact. The user (110, 112, and/or 114) is provided an option to chat in at least one of multiple available languages. During the chat, the user (110, 112, and/or 114) is also provided an option to use emoticons and symbols. To interact with the contacts, the user (110, 112, and/or 114) can input messages via the remote control device associated with the user device 118 of the user (110, 112, and/or 114). Although a textual chat is described, an audio and/or video chat is also possible. To provide input in an audio chat, the user (110, 112, and/or 114) can input voice via a microphone embedded in the remote control device or via a separate microphone/speaker conferencing system provided to the user (110, 112, and/or 114). To provide input in a video chat, the user (110, 112, and/or 114) can input video via a camera embedded in the remote control device or a camera connected to the set top box 120 provided to the user (110, 112, and/or 114). While the microphone and/or the camera are described as being embedded in the remote control device, in some other implementations, the microphone and/or the camera can also be externally attached to the user device 118 of the user (110, 112, and/or 114). In an alternate implementation, the graphical user interface 1000 can display various elements based on an aesthetic display design 1402, which is described below in more detail.

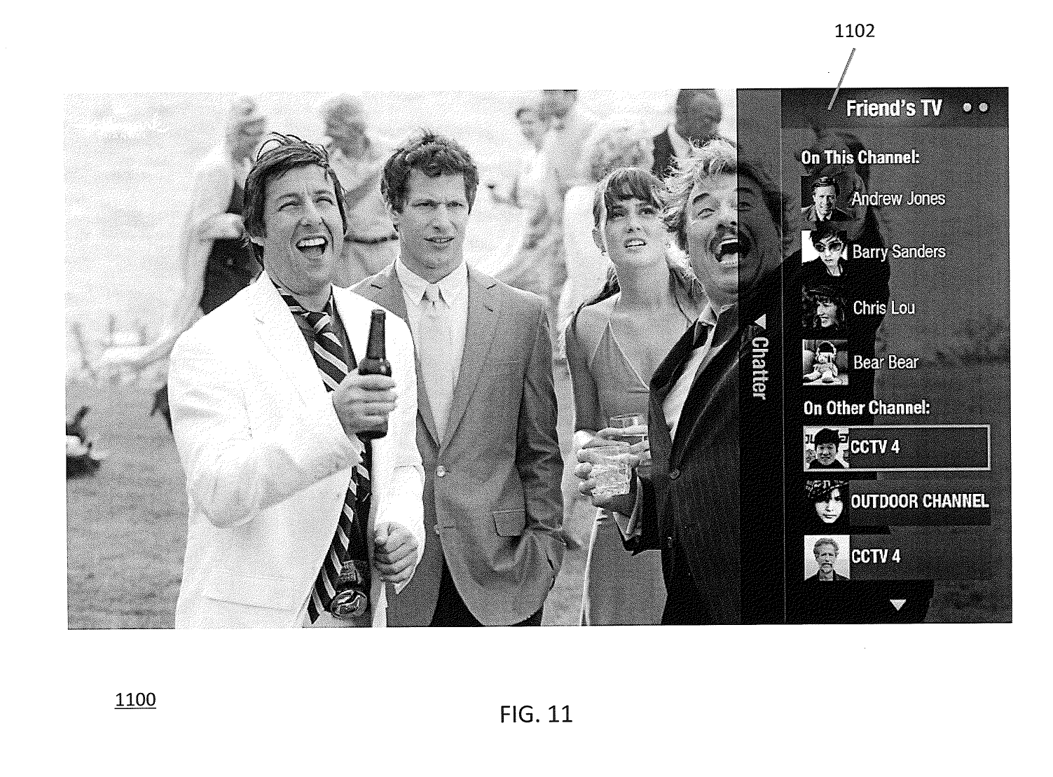

FIG. 11 is a diagram illustrating a third graphical user interface 1100 that allows a group-watch of a channel by different users (110, 112, and/or 114) in a virtual living room. The chat window 1002 can be changed to a friends-window 1102 that displays the contacts viewing the selected channel that is being hosted by the contact “Andrew Jones” (that is, the channel for which the contact “Andrew Jones” is a subscriber and is viewing the channel, while contacts of “Andrew Jones” are viewing the channel by virtue of being his contacts and irrespective of whether those contacts have subscribed to the channel). The friends-window 1102 can also display the contacts that are not viewing the selected channel that is being hosted by the contact “Andrew Jones,” and their presence status with respect to other channels that they are viewing. Further, the friends-window 1102 displays icons for those other channels being viewed by the contacts that are not viewing the selected channel. In an alternate implementation, the graphical user interface 1100 can display elements as displayed by graphical user interface 1702, which is described below in more detail.

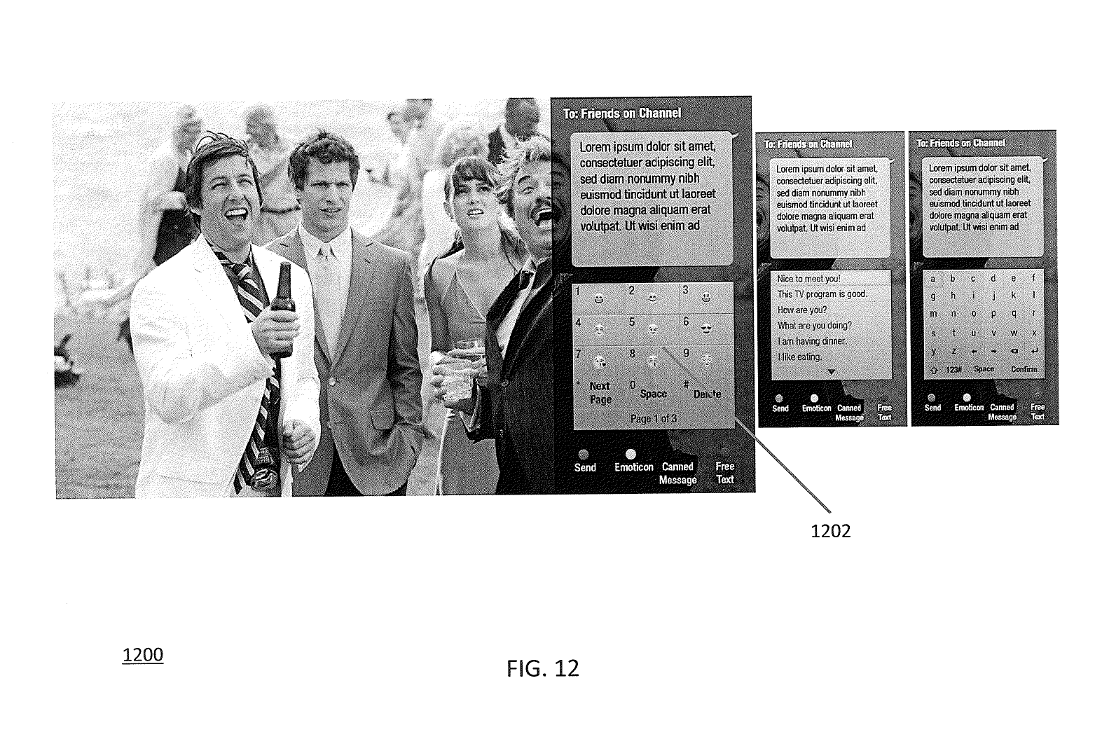

FIG. 12 is a diagram illustrating a third graphical user interface 1200 that allows a group-watch of a channel by different users (110, 112, and/or 114) in a virtual living room. With the remote control provided to the user (110, 112, and/or 114), the user (110, 112, and/or 114) can send messages to one or more contacts. The user (110, 112, and/or 114) can send a single message to all contacts, or can individually select a contact and send messages to the selected contact. The window 1202 can provide different emoticons, which the user (110, 112, and/or 114) can select and insert within a message. In an alternative implementation, the graphical user interface 1200 can display elements as displayed by graphical user interface 1502, which is described below in more detail.

As noted above, the users (110, 112, and/or 114) that are connected and are viewing a same channel can communicate via text messages, audio messages, and/or video messages. More than two users (110, 112, and/or 114) can communicate with each other simultaneously, thereby forming a virtual living room where people can view a same channel and discuss about the viewed channel. Two or more users (110, 112, and/or 114) can also communicate privately via private messages. Further, a user (110, 112, and/or 114) can also communicate, either privately or publically, with a public user who may not be in a same virtual living room as the user (110, 112, and/or 114). The graphical user interface 1202 can optionally present the communication history (if available) for each conversation between the user (110, 112, and/or 114) of the graphical user interface 1202 and any other user.

For audio communication, the background noise can be reduced so that only voice and utterances are transmitted to contacts in the virtual living room. The background noise in audio communication is reduced as noted below. When a user (110, 112, and/or 114) speaks, the audio signal is obtained at the set top box 120 of the user (110, 112, and/or 114). The set top box 120 of the user (110, 112, and/or 114) then matches and extracts the differences between the original stream of the channel and the recorded audio signal, which can include the audio in the original stream and the voice message by the user (110, 112, and/or 114). If a level of the differences is more than a threshold value (for example, 30 decibel, 40 decibel, 50 decibel, 70 decibel, or other threshold values), the recorded audio signal likely includes the voice message by the user (110, 112, and/or 114) rather than merely noise, and the set top box 120 of the user (110, 112, and/or 114) can transmit the recorded audio signal to other users. If the level of the differences is less than the threshold value, the audio signal likely includes merely noise, and the set top box 120 of the user (110, 112, and/or 114) does not transmit the recorded audio signal to other users (110, 112, and/or 114) over the network 116, such as internet. Such a prevention of transmission of noise saves bandwidth cost and preserves highest audio quality of the audio communication between users (110, 112, and/or 114). Further, echo reduction and/or cancelling techniques can be employed in the set top boxes 120 and the microphone/speaker systems to eliminate or reduce (for example, minimize) echo resulting from the voices and utterances of one or more users (110, 112, and/or 114) in the room, as these voices and utterances can bounce back into the microphone.

The microphone system can include an array structure that can be implemented to maximize the signal to noise ratio within the virtual living room. The array structure can implement digital signal processing techniques. The microphone array structure can capture audio voices and utterances of the users (110, 112, and/or 114) that are both near and far from the microphone system. The microphone system can be deployed in the center of each room where the user (110, 112, and/or 114) is located. The array structure can be implemented as a strip of multiple microphones attached to the user device 118. In one implementation, the strip of microphones can run across the entire bottom of the user device 118 to form a sound bar. The microphones can communicate with one or multiple digital signal processors (DSPs). The DSPs provide for the ability to individually “steer” the reception of each of the microphones embedded in the microphone array strip to pick up the voices and utterances of different users (110, 112, and/or 114) that may be located in different places (for example, center, close to center, fringes, corners, and/or the like) in a room. The array can cover the expanse of the entire horizontal length or/and breadth of a face of the user device 118. The long length of the array allows a significant number of microphones to be used. Because of this significant number of microphones and because of these significant numbered microphones being in a straight line, the quality of the audio pickup is significantly better than conventional systems. Thus, the quality of audio heard at the one or more receiving ends of the virtual living room group is superior to that associated with conventional systems.

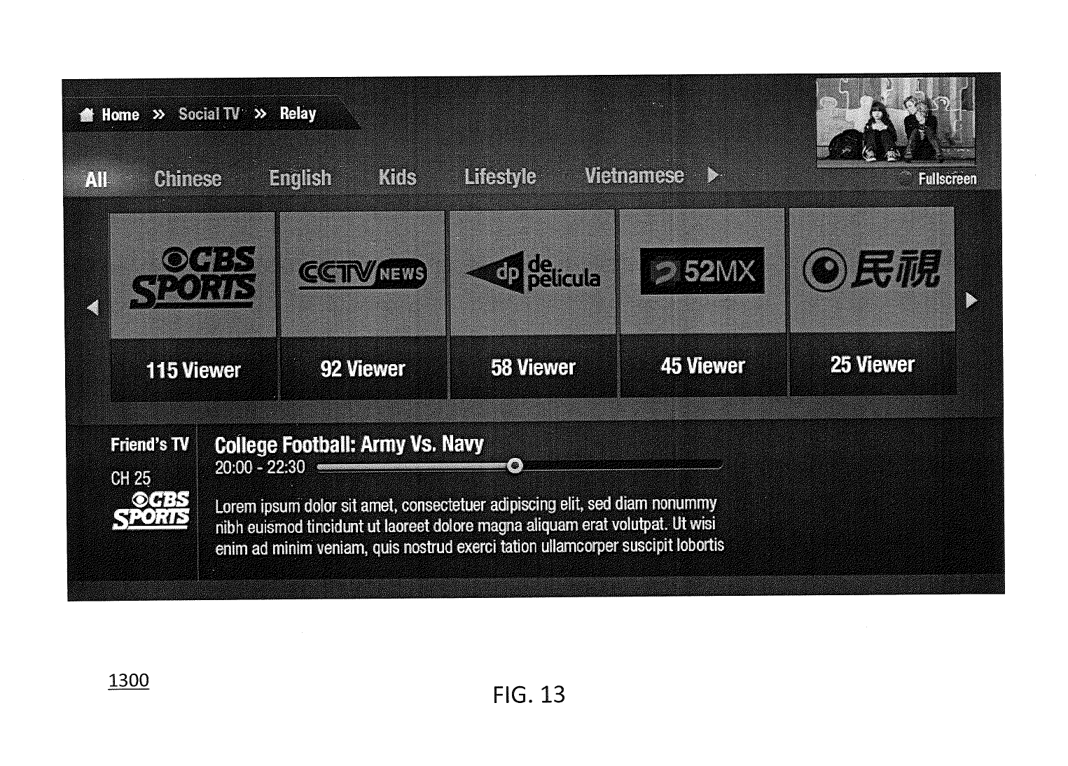

FIG. 13 is a diagram illustrating a third graphical user interface 1300 that displays channels available for a user (110, 112, and/or 114). The graphical user interface 1300 displays icons of some channels. Each of these icons further displays a number of viewers viewing the channel. The graphical user interface 1300 displays icons of the channels in an order based on one or more of: preferences of the viewer, number of friends simultaneously viewing a particular channel, activity of conversations for each channel, keywords (describing the context of the content being watched) that can be pulled from the conversations, frequency of views of each channel by the user (110, 112, and/or 114), subscribed channels, unsubscribed channels, and other criteria. In one example, if a user (110, 112, and/or 114) generally views sports channels and discusses various sports with other contacts in virtual living rooms, the graphical user interface 1300 can display more sports channels followed by other channels associated with sports. Similarly, if another user often views cooking channels and discusses cooking techniques with other contacts in virtual living rooms, the graphical user interface 1300 can display more cookery channels followed by other channels associated with cooking.

In another implementation, the icons of the channels can be displayed on the graphical user interface 1300 in an order of popularity, which is characterized by the number of viewers currently viewing the channels. In some other implementations, the icons of the channels can be displayed on the graphical user interface 1300 in an order of popularity of a particular user based on a combination of number of viewers and their preferences; thus, the display of the icons can be different for each user (110, 112, and/or 114) in this implementation. In another implementation, the icons of the channels can be displayed on the graphical user interface 1300 in an alphabetical order of channel name or channel number. In yet another implementation, icons of the channels can be displayed on the graphical user interface 1300 based on number of previous views by the user (110, 112, and/or 114). In one implementation, the user device 118 allows the user (110, 112, and/or 114) to prepare a list of favorite channels and assign a rank to each channel. The graphical user interface 1300 can then display the icons of favorite channels arranged according to their respective ranks.

The graphical user interface 1300 can further display premium channels that may be available for viewing to both subscribers (110, 112) and the non-subscriber 114. The user device 118 of the non-subscriber 114 can display the premium free channel to the non-subscriber 114 irrespective of whether any contact of the non-subscriber 114 is subscribed to the service and viewing the premium channel. Thus, the premium channels can always be available to any user (110, 112, and/or 114). Such premium channels can encourage new users to view those premium channels, and eventually become subscribers to view other payment-requiring channels. The user (110, 112, and/or 114) can click on any premium channel displayed on the graphical user interface 1300, and join a common virtual living room that includes all the users viewing the premium channel. In some implementations, the user (110, 112, and/or 114) can optionally elect to communicate with only the contacts of the user (110, 112, and/or 114) who are in the virtual living room, and not with other viewers in the virtual living room. The service provider can manage the rights to the content of the displayed channel so that the non-subscriber can watch the channel for just a predetermined amount of time.

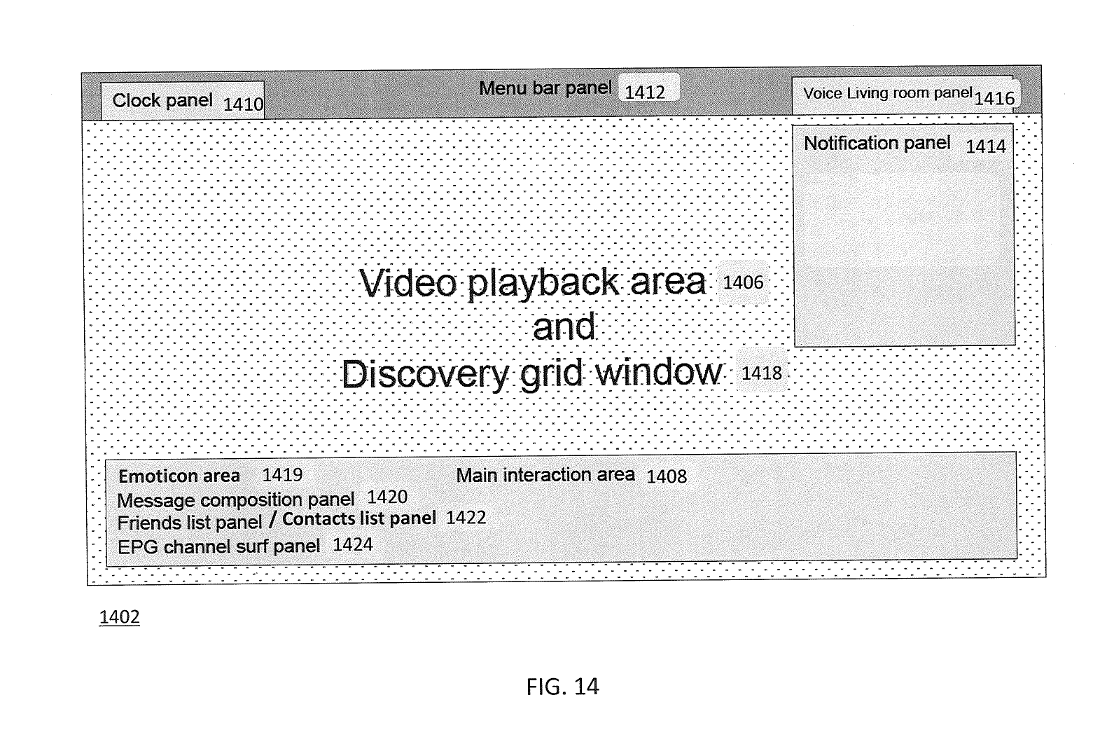

FIG. 14 illustrates an aesthetic display design 1402 of one example of a graphical user interface 1404 executed by the user device 118. The display design 1402 includes placing of various elements, which include a video playback area 1406, a main interaction area 1408, a clock panel 1410, a menu bar panel 1412, a notification panel 1414, a voice living room panel 1416, and a discovery grid window 1418. The user device 118 can semi-transparently superimpose data of at least some of these elements on the video of the video channel displayed on the graphical user interface 1404.

The graphical user interface 1404 can present a video playback option to a user (110, 112, and/or 114). When the user (110, 112, and/or 114) selects the video playback option for a stored or previously displayed video, the graphical user interface 1404 displays a playback of the video in the video playback area 1406. In one variation, when the user (110, 112, and/or 114) selects the video playback option for a stored or previously displayed video, the graphical user interface 1404 displays a playback of the video on the entire graphical user interface 1404 without displaying any other element.

The main interaction area 1408 includes an emoticon area 1419, a message composition panel 1420, a contacts list panel 1422, and an electronic program guide (EPG) channel surf panel 1424. The emoticon area 1419 displays all emoticons that the user (110, 112, and/or 114) can use while entering commands or sending messages to contacts by using the remote control device of the user device 118. The message composition panel 1420 allows a user (110, 112, and/or 114) to compose messages that can include emoticons, and to send those composed messages to contacts of the user (110, 112, and/or 114). The contacts list panel 1422 displays contacts of the user (110, 112, and/or 114) that are currently online, and allows the user (110, 112, and/or 114) to select one or more displayed contacts and to interact with the selected contacts. The electronic program guide (EPG) channel surf panel 1424 can be displayed when a user (110, 112, and/or 114) scrolls through channels within a subscribed channel list. Some elements of the graphical user interface 1404 are described in more detail below.

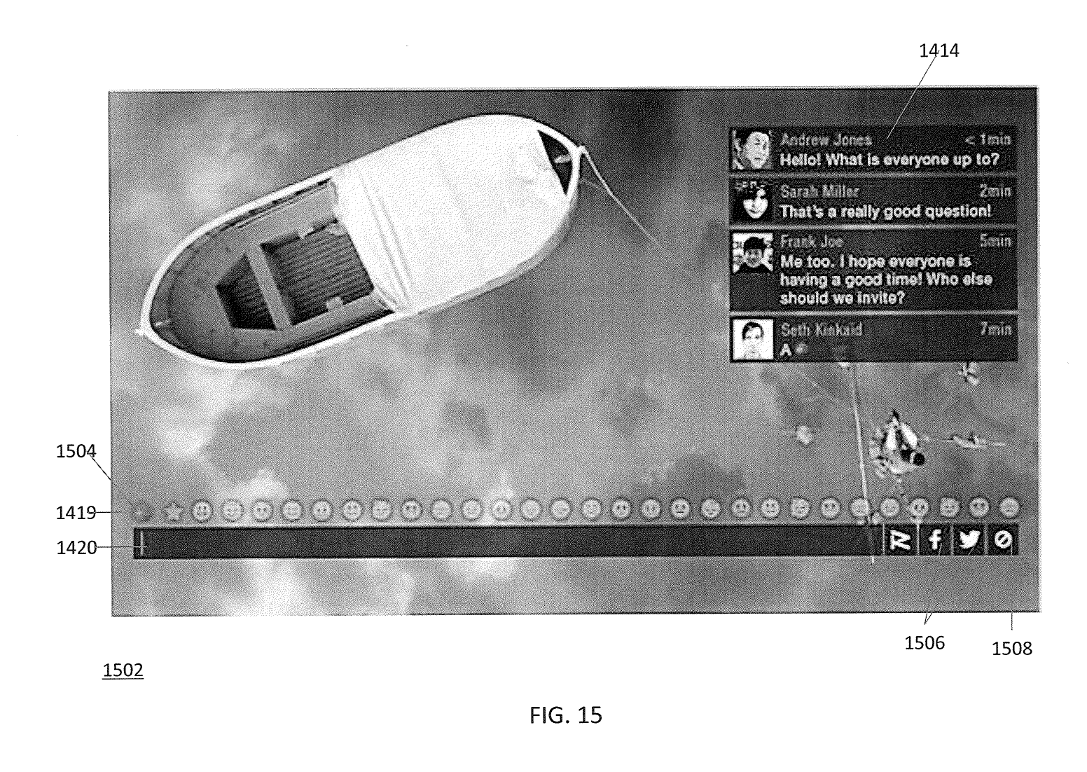

FIG. 15 illustrates a graphical user interface 1502 displaying the emoticon area 1419, the message composition panel 1420, and the notification panel 1414. The user device 118 executes the graphical user interface 1502. The graphical user interface 1502 displays various elements based on the display design 1402. The graphical user interface 1502 activates the message composition panel 1420 when the user (110, 112, and/or 114) presses a keyboard button (for example, QWERTY keyboard button) on a keyboard of the remote control device of the user device 118. The message composition panel 1420 displays the numeral, letter, or symbol pressed by the user (110, 112, and/or 114) on the keyboard. When the user (110, 112, and/or 114) presses an emoticon button on the keyboard, the graphical user interface 1404 activates the emoticon area 1419. When activated, the emoticon area 1419 displays all available emoticons. The message composition panel 1420 allows a user (110, 112, and/or 114) to enter a maximum of a predetermined number of characters, such as 140 characters. The message composition panel 1420 replaces last character with any additional character that the user (110, 112, and/or 114) enters after entering 140 characters.

When the user (110, 112, and/or 114) begins composing a message in the message composition panel 1420, the graphical user interface 1404 can activate a notification panel 1414. The activated notification panel 1414 can display recent messages (for example, messages sent and received with a past preset time period) between the user (110, 112, and/or 114) and various contacts. The display of recent messages advantageously allows the user (110, 112, and/or 114) to view the messages in case the user (110, 112, and/or 114) is responding to at least one of the recent messages.

When the user (110, 112, and/or 114) presses an up-direction key of a directional pad of a remote control device of the user device 118 while composing a message in the message composition panel 1420, the graphical user interface 1404 highlights (for example, brightens) and/or increases the visibility (for example, increases size and/or opacity) of the emoticons displayed in the emoticon area 1419. The graphical user interface 1404 allows the user (110, 112, and/or 114) to navigate within the emoticon area 1419 by using the direction keys on the directional pad of the remote control device. When the user (110, 112, and/or 114) selects (for example, points over) an emoticon by using the remote control device, the graphical user interface 1404 can increase the size of the selected emoticon in the emoticon area 1419 so that the user (110, 112, and/or 114) can visually differentiate the selected emoticon from other emoticons.

The emoticons in the emoticon area 1419 include standard emoticons and unique emoticons, such a tomato emoticon 1504. Unique emoticons are also referred to as funimoticons or funny emoticons. Although a tomato emoticon 1504 is described, in some variations, other unique emoticons can be alternately or additionally used, such as fruits, vegetables, flowers, animals, food, and/or other emoticons.

When a user (110, 112, and/or 114) selects any emoticon, the emoticon is displayed in the message composition panel 1420 of the graphical user interface 1404 of the user (110, 112, and/or 114). When a user (110, 112, and/or 114) presses a unique emoticon button on the remote control device of the user device 118 to activate a unique emoticon mode, selects a unique emoticon from the emoticon area 1419, and performs a preset movement with the remote control device, the graphical user interface 1404 can display the selected unique emoticon in the video playback area 1406 (as described below with respect to graphical user interface 1602) of user devices 118 of both the user (110, 112, and/or 114) and one or more intended recipients, who can be contacts of the user (110, 112, and/or 114). Simultaneously, the audio accompaniment for the emoticon can generate a corresponding sound in the audio speaker attached to or within each respective user device 118.

Further, while using the message composition panel 1420, the user (110, 112, and/or 114) can click a voice button on the remote control device of the user device 118. When the user (110, 112, and/or 114) clicks this voice button, the message composition panel 1420 displays an icon for a microphone that gradually brightens and/or increases in size. Subsequently, the user (110, 112, and/or 114) can keep a press-to-talk button pressed on the remote control device to speak into a microphone embedded in the remote control device. When the user (110, 112, and/or 114) speaks into the microphone, the displayed icon for the microphone can lighten up for convenience of the user (110, 112, and/or 114). A voice button of the remote control device can also perform voice to text conversion. This voice button can be dedicated or exclusive for performing voice to text conversion. The graphical user interface 1404 can then display the converted text data in the notification panels 1414 of both the user (110, 112, and/or 114) and one or more intended recipients (if any).

The message composition panel 1420 includes icons 1506 for third party social networks, such as one or more of: FACEBOOK, LINKEDIN, TWITTER, blogs, or any other social network. When the user (110, 112, and/or 114) selects an icon 1506 for a third party social network, the graphical user interface 1502 allows the user (110, 112, and/or 114) to share one or more messages composed in the message composition panel 1420 to the third party social network associated with the selected icon 1506. In some implementations, the voice messages or voice-to-text converted text messages can also be shared via third party social networks. The message composition panel 1420 includes a cancel button 1508. When the user (110, 112, and/or 114) selects the cancel button 1508, the graphical user interface 1502 cancels the sharing of the messages via the third party social networks. The remote control device includes a back button, which, when selected by the user (110, 112, and/or 114), can alternately be used to cancel the sharing of the messages.

The notification panel 1414 displays messages characterizing a chat between a user (110, 112, and/or 114) and one or more contacts of the user (110, 112, and/or 114). For one to one messages, the notification panel 1414 displays conversations between a user (110, 112, and/or 114) and each contact of the user (110, 112, and/or 114) in a separate corresponding chat window. For messages involving a virtual living room comprising more than two users (110, 112, and/or 114), the notification panel 1414 displays a separate chat window for a chat in each virtual living room. The notification panel 1414 can implement a fade-out animation where messages received or sent more than a predetermined time (for example, seven seconds) ago are automatically removed from display. The menu bar panel 1412 provides an option that the user (110, 112, and/or 114) can use to view associated historical chat messages. With one or more messages in each chat window, icons for social networks, email, and other sharing tools are provided.

When the user (110, 112, and/or 114) clicks on an icon 1506 for a sharing tool, the user (110, 112, and/or 114) can share that message via the associated social network, email, text message, or any other related mechanism. In some implementations, the user (110, 112, and/or 114) can click on the icon 1506 for the sharing tool to share the entire chat history or any desired portion of the entire chat history. Any post that is posted on the sharing tool is also posted on an administrative account for the sharing tool. For private messages between two or more users (110, 112, and/or 114), the notification panel 1414 can display an envelope-shaped icon next to those messages so that the user (110, 112, and/or 114) can identify the private messages.

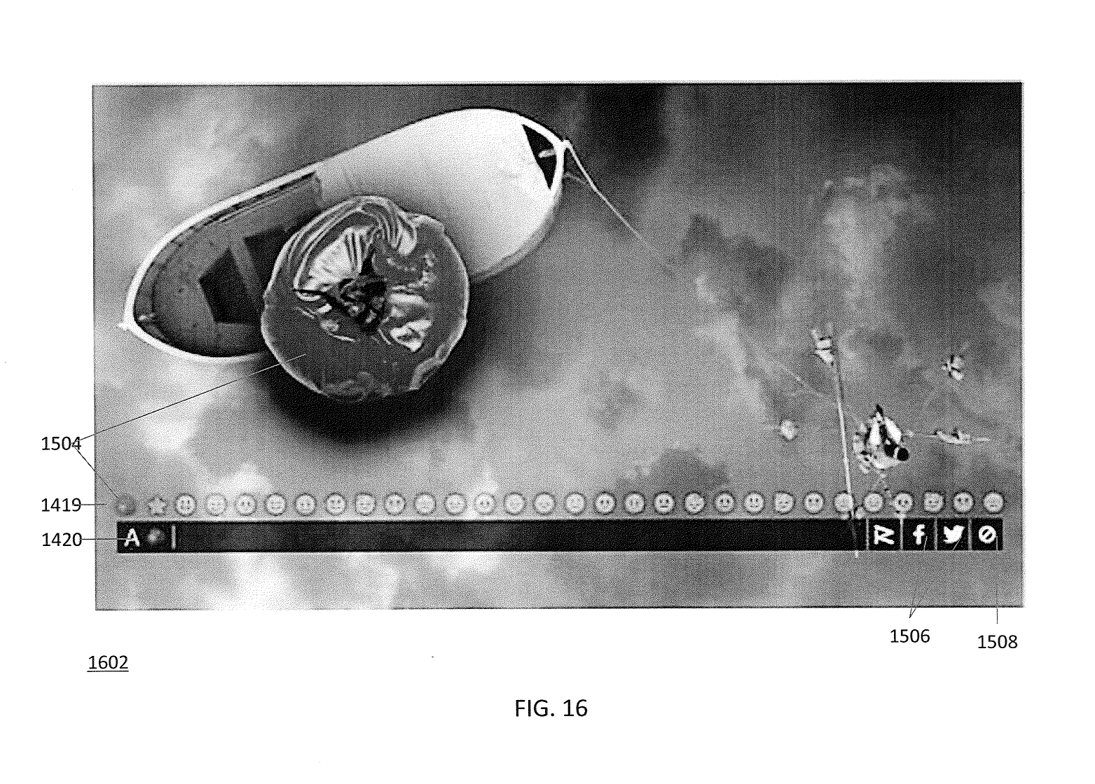

FIG. 16 illustrates a graphical user interface 1602 displaying a unique emoticon 1504 splashed in the video playback area 1406. The user device 118 executes the graphical user interface 1602. The graphical user interface 1602 displays various elements based on the display design 1402. The graphical user interface 1602 can display the unique emoticon 1504 in the video playback area 1406 when a user (110, 112, and/or 114) presses a unique emoticon button on the remote control device of the user device 118 to activate a unique emoticon mode, selects a unique emoticon 1504 from the emoticon area 1419, and performs a preset movement with the remote control device. Some examples of the preset movement can be one or more of: rotation of the remote control device, quickly movement of the remote control device in any direction, quick movement of the remote control device in a particular direction, or any other performs movement. The selected unique emoticon 1504 can be displayed in the video playback area 1406 of the recipient contact while overlying the displayed video of the channel.

When the unique emoticon 1504 is displayed in the video playback area 1406, the size of the unique emoticon 1504 is enlarged so that the intended recipient can be notified easily.

When the unique emoticon 1504 is activated, another preset movement—similar to those noted above—of the remote control device by the user (110, 112, and/or 114) causes the video display areas 1406 of both the user and one or more intended recipients to display another previously-displayed unique emoticon 1504. The activated unique emoticon mode can be deactivated when the user (110, 112, and/or 114) presses the unique emoticon button again on the remote control device, or when the user (110, 112, and/or 114) does not press any button on the remote for a preset time period (for example, 30 seconds) after the activation.

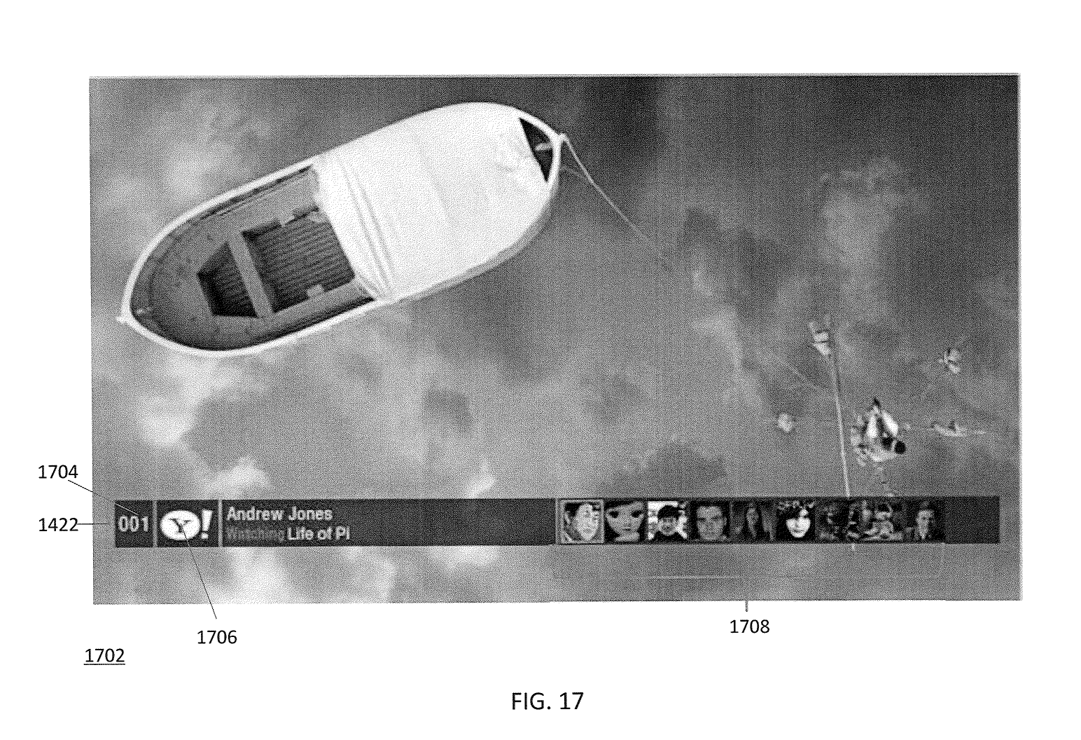

FIG. 17 illustrates a graphical user interface 1702 displaying the contacts list panel 1422. The user device 118 executes the graphical user interface 1702. The graphical user interface 1702 displays various elements based on the display design 1402. The contacts list panel 1422 can display: a channel number 1704 of the channel being displayed, a logo 1706 of the channel being displayed, and icons 1708 of contacts of the user (110, 112, and/or 114) that are currently online. The displayed icons 1708 of the contacts can be displayed alphabetically, according to an order customized by the user (110, 112, and/or 114), and/or any other order. The icons of contacts, to whom a same program is being displayed as that displayed to the user (110, 112, and/or 114), can be highlighted (for example, indicated with a colored check mark, boundaries indicated with a colored scheme, and/or other ways of highlighting) while icons of other contacts can be dimmed. The direction keys on the directional pad of the remote control device can allow the user (110, 112, and/or 114) to scroll through various displayed friends.

When the user (110, 112, and/or 114) selects an icon of a particular highlighted contact, the contacts list panel 1422 can display: an icon allowing the user (110, 112, and/or 114) to call the selected contact, and an icon allowing the user (110, 112, and/or 114) to send a message to the selected contact. When the user (110, 112, and/or 114) selects an icon of a dimmed contact, the contacts list panel 1422 can display: an icon to invite the selected contact to view the channel displayed to the user (110, 112, and/or 114), an icon to enable the channel displayed to the dimmed contact to be displayed to the user (110, 112, and/or 114) so that the user (110, 112, and/or 114) can join the selected contact, and an icon allowing the user (110, 112, and/or 114) to send a message to the selected contact.

When the user (110, 112, and/or 114) scrolls over (for example, by using left or right direction keys on the directional pad of the remote control device) a contact, the graphical user interface 1702 can display: the channel being currently displayed to the contact selected by the scrolling process, and a number of participants or viewers in a virtual living room if the selected contact is watching the channel as a part of the virtual living room, or a list of contacts who are online but not watching in the same virtual living room. When the user (110, 112, and/or 114) selects the contact selected by the scrolling process by clicking on the icon for the contact, the one or more server computers 102 can automatically include the user (110, 112, and/or 114) in the virtual living room of the selected contact by synchronously relaying and displaying the video channel of the virtual living room to the user (110, 112, and/or 114) and the selected contact. Thus, the user (110, 112, and/or 114) joins the selected contact at the current frame of the video being displayed rather than from the beginning of the video.

The menu bar panel 1412 provides an option that the user (110, 112, and/or 114) can use to hide the contacts list panel 1422.

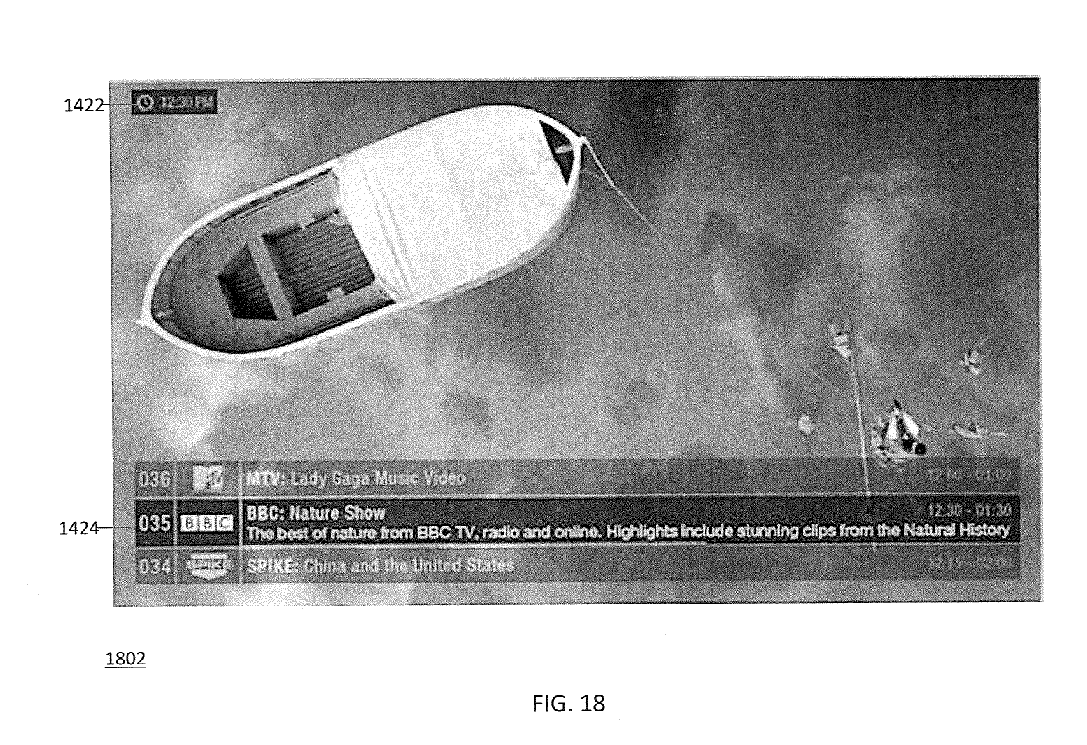

FIG. 18 illustrates a graphical user interface 1802 displaying the electronic program guide (EPG) channel surf panel 1424 and the clock panel 1410. The user device 118 executes the graphical user interface 1802. The graphical user interface 1802 displays various elements based on the display design 1402. The EPG channel surf panel 1424 displays details associated with channels as the user (110, 112, and/or 114) surfs subscribed channels using the direction keys on the directional pad of the remote control device. The EPG channel surf panel 1424 is displayed when the user (110, 112, and/or 114) presses the up direction key or the down direction key on the directional pad. The EPG channel surf panel 1424 can display icons and other details (for example, channel number, program being displayed, and a brief description of the displayed program) of three channels in a vertical format, wherein the middle channel can be the channel currently displayed. The EPG channel surf panel 1424 may display the brief description of the program for only the channel that is currently being displayed.

The clock panel 1410 includes a clock that displays current time. The graphical user interface 1802 displays the clock panel 1410 when the graphical user interface 1802 displays the EPG channel surf panel 1424.

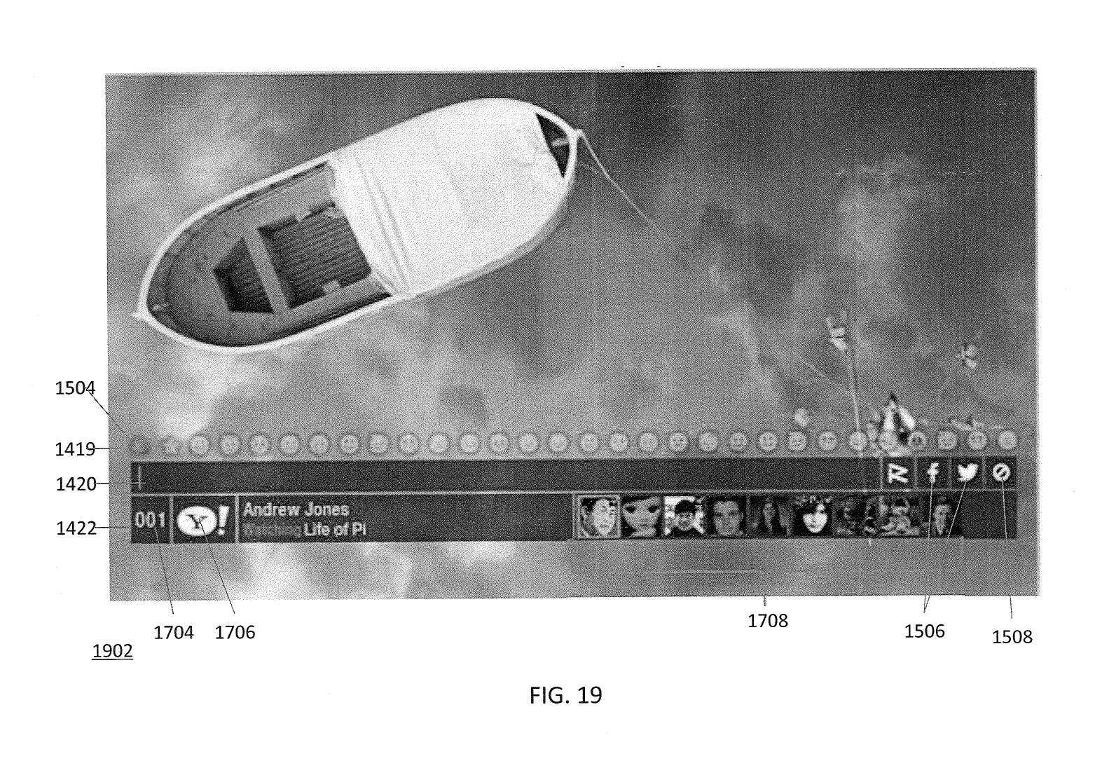

FIG. 19 illustrates a graphical user interface 1902 displaying the emoticon area 1419, the message composition panel 1420, and the contacts list panel 1422. The user device 118 executes the graphical user interface 1902. The graphical user interface 1902 displays various elements based on the display design 1402. The user device 118 can enable interaction between the emoticon area 1419, the message composition panel 1420, the contacts list panel 1422, and EPG channel surf panel 1424. For example, when the user (110, 112, and/or 114) presses the QWERTY keyboard while contacts list panel 1422 is activated, the graphical user interface can display the message composition panel 1420 above the contacts list panel 1422, which continues to display the list of contacts. To prevent a conflict of input data via the remote control device, the EPG channel surf panel 1424 can be prevented from being displayed simultaneously with any one or both of the message composition panel 1420 and the contacts list panel 1422.

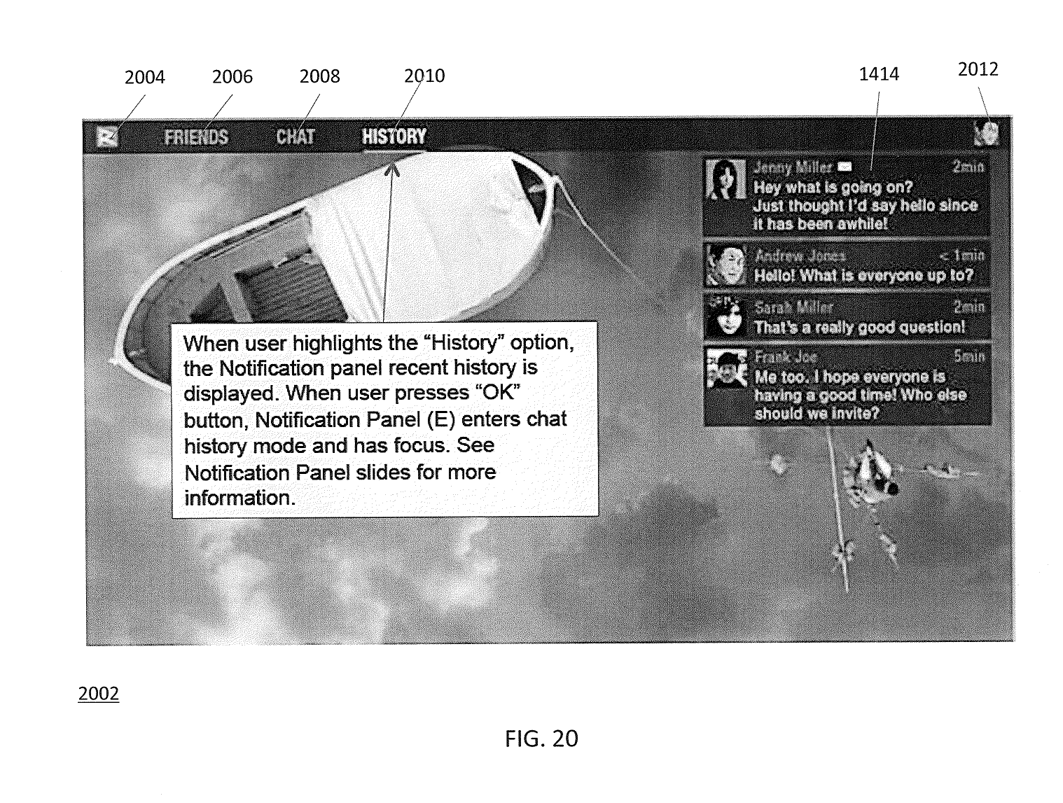

FIG. 20 illustrates a graphical user interface 2002 displaying the menu bar panel 1412. The menu bar panel 1412 includes a menu button 2004, a friends tab 2006, a chat tab 2008, a history tab 2010, and a profile tab 2012. The user device 118 executes the graphical user interface 2002. The graphical user interface 2002 displays various elements based on the display design 1402. The menu button 2004 allows the user (110, 112, and/or 114) to activate or deactivate the menu bar panel 1412. The friends tab 2006 allows the user (110, 112, and/or 114) to turn on or turn off display of contacts in the contacts list panel 1422 and to activate a privacy mode. When the privacy mode is activated, the system can no longer know what channel is currently being watched by the viewer, and thus, the contacts of the viewer can no longer watch together with this viewer. The chat tab 2008 allows the user (110, 112, and/or 114) to chat, by sending and/or receiving one or more messages, with one of: everyone, contacts only, and nobody. The history tab 2010 allows the user (110, 112, and/or 114) to view chat history in the notification panel 1414. When the graphical user interface displays the menu bar panel 1412; the emoticon area 1419, the message composition panel 1420, the contacts list panel 1422, and the notification panel 1414 can be activated while other panels may not be activated. The profile tab 2012 displays the profile photo of the user (110, 112, and/or 114). When the user (110, 112, and/or 114) clicks the profile tab 2012, the user (110, 112, and/or 114) is allowed to view, add, delete, and/or modify the details of the user's registration with the subscription service. The details associated with the subscription service can include: profile photo, credit balance, latest purchase, number of friends, email address, and/or other data.

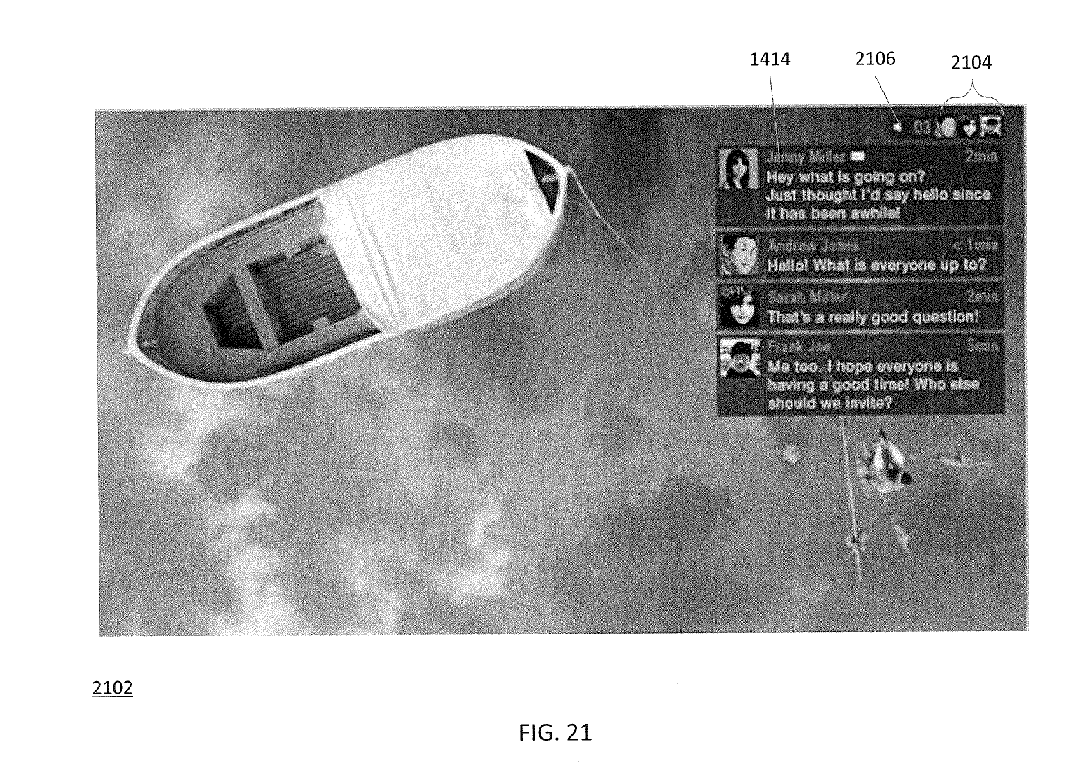

FIG. 21 illustrates a graphical user interface 2102 displaying the voice living room panel 1416. The user device 118 executes the graphical user interface 2102. The graphical user interface 2102 displays various elements based on the display design 1402. The voice living room panel 1416 displays icons 2104 of contacts and possibly other users that are in a current voice session with the user (110, 112, and/or 114) and that are being displayed a same channel as that displayed to the user (110, 112, and/or 114). These contacts and possibly other users may have been previously invited by the user (110, 112, and/or 114) to join the voice session of the virtual living room. The voice living room panel 1416 can display an icon 2106 for a microphone that the user (110, 112, and/or 114) can use to vary the volume. To avoid conflict of space, when the graphical user interface 2102 displays the voice living room panel 1416, the graphical user interface 2102 may not display any of the menu bar panel 1412 and the discovery grid window 1418.

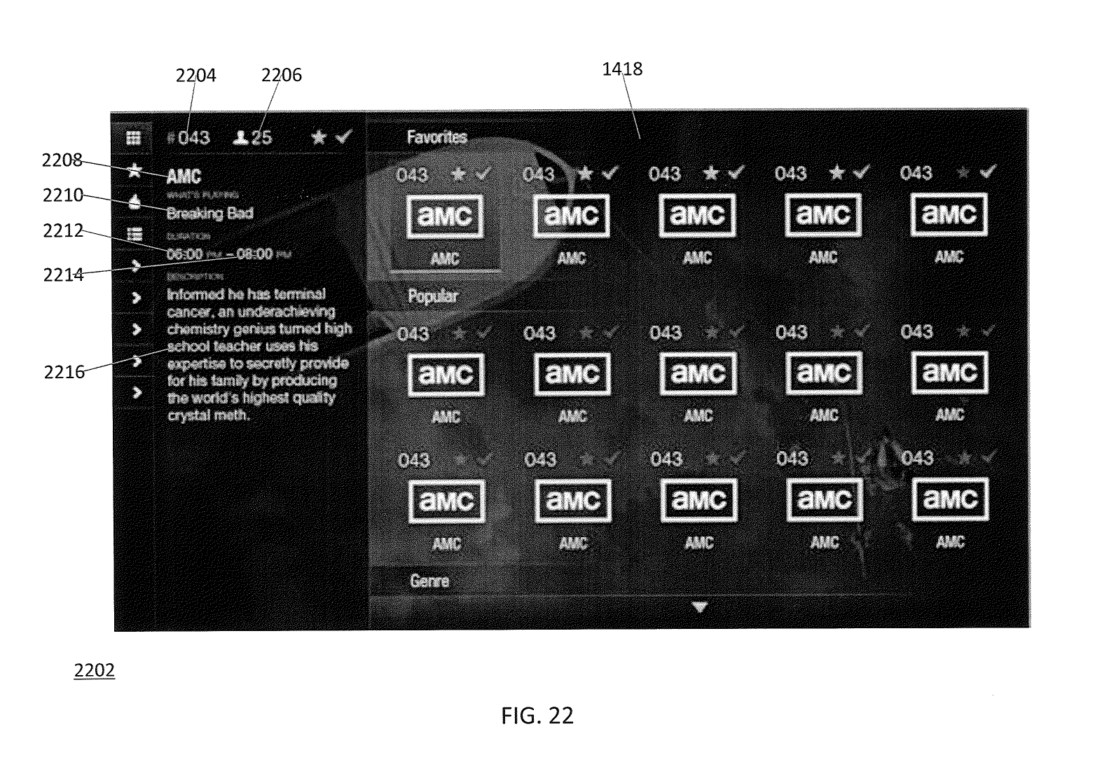

FIG. 22 illustrates a graphical user interface 2202 displaying a discovery grid window 1418. The user device 118 executes the graphical user interface 2202. The graphical user interface 2202 displays various elements based on the display design 1402. The discovery grid window 1418 can display all the available channels irrespective of the user's subscription status for each of those channels. The graphical user interface displays the discovery grid window 1418 when the user (110, 112, and/or 114) presses the OK button or Enter button on the remote control device when the main interaction area 1408 and the notification panel 1414 are not displayed, as in this situation there is no conflict in using the OK button or Enter button. The discovery grid window 1414 allows the user (110, 112, and/or 114) to group/filter the available channels according to at least one of: favorite channels, popular channels, genre, type, alphabetically, numerical order of channel numbers, subscription status, and any other criteria. Some examples of genres include: Chinese, any other language, lifestyle, news, sports, business, and other possible genres. The discovery grid window 1414 allows the user (110, 112, and/or 114) to add any desired channel to favorite channels, and rank the added channel as compared to other favorite channels.

Additionally, the discovery grid window 1414 displays data describing the current channel. The data describing the current channel includes: the channel number 2204, popularity of the channel (for example, current popularity characterized by number 2206 of contacts currently viewing the channel), name 2208 of the channel, name 2210 of a current program on the channel, a start time 2212 and an end time 2214 of the program, and a brief description 2216 of the program.

TABLE 1 describes button handling among various panels in order of priority.

TABLE 1

| Priority | Key | Condition | Action to perform |
|---|---|---|---|
| Highest | Menu button | Any | Open/activate or close menu bar. Close discovery grid if |
| [symbol] | | | it is active |
| Lowest | Any | Menu bar displayed | Menu bar handle key. |
| | Any | Discovery grid displayed | Discovery grid handle key. |
| | QWERTY or | None of the above | Exit chat history mode if active. Exit EPG channel surf if |
| | emoticon | | active. Open message composition panel B-1 |
| | Non-QWERTY, non- | Chat History mode | Handle key and do not pass to other panels |
| | emoticon | | |
| | Any | Message composition | Handle key and do not pass to other panels |
| | | displayed | |
| | Left, Right, OK keys | Friends list displayed | Friends list handles keys |
| | Up, down keys | Friends list displayed | Hide friends list, open EPG channel surf |
| | Any | EPG channel surf displayed | Handle in EPG channel surf. |
| | OK | None of the above | Open discovery grid |

In one possible implementation, the client application 302 can allow a user (110, 112, and/or 114) to become a moderator of a virtual living room. The moderator can have followers that are users following the moderator. The one or more servers 102 can relay comments (for example, textual comments and/or audio comments) of the moderator during display of a video channel to the followers in real-time (that is, as the moderator writes and/or speaks). The moderator (for example, a celebrity, such as Roger Federer) can inform various people that he/she will be commentating during an event (for example, the French Open tennis final) relayed and displayed on a video channel. The moderator can inform the people about this via a third party social network, a website, a print media, television advertisement, and/or the like. These people can join the virtual living room at any point during the commentary. The one or more servers 102 can simultaneously relay and display same video frames of the event (for example, the French Open tennis final) to all the users in the virtual living room (including new users that may be joining at various points in time) while simultaneously relaying same commentary by the moderator (for example, Roger Federer).

In some implementations, the moderator can leave the global following mode, and jump to contacts only mode, which is when the one or more servers 102 relay the comments of the moderator to only the contacts of the moderator. In the global mode, the moderator can have the option to receive text messages from any follower. The moderator can also individually choose to reply to at least some of the messages. During the global mode, the moderator can continue to talk to his/her contacts, wherein the voice of the contacts can also be relayed to all the followers of Roger Federer. During the contacts only mode, the moderator can receive text message and/or talk to the contacts.

Various implementations of the subject matter described herein can be realized/implemented in digital electronic circuitry, integrated circuitry, specially designed application specific integrated circuits (ASICs), computer hardware, firmware, software, and/or combinations thereof. These various implementations can be implemented in one or more computer programs. These computer programs can be executable and/or interpreted on a programmable system. The programmable system can include at least one programmable processor, which can be have a special purpose or a general purpose. The at least one programmable processor can be coupled to a storage system, at least one input device, and at least one output device. The at least one programmable processor can receive data and instructions from, and can transmit data and instructions to, the storage system, the at least one input device, and the at least one output device.

These computer programs (also known as programs, software, software applications or code) can include machine instructions for a programmable processor, and can be implemented in a high-level procedural and/or object-oriented programming language, and/or in assembly/machine language. As can be used herein, the term “machine-readable medium” can refer to any computer program product, apparatus and/or device (for example, magnetic discs, optical disks, memory, programmable logic devices (PLDs)) used to provide machine instructions and/or data to a programmable processor, including a machine-readable medium that can receive machine instructions as a machine-readable signal. The term “machine-readable signal” can refer to any signal used to provide machine instructions and/or data to a programmable processor.

To provide for interaction with a user, the subject matter described herein can be implemented on a computer that can display data to one or more users on a display device, such as a cathode ray tube (CRT) device, a liquid crystal display (LCD) monitor, a light emitting diode (LED) monitor, or any other display device. The computer can receive data from the one or more users via a keyboard, a mouse, a trackball, a joystick, or any other input device. To provide for interaction with the user, other devices can also be provided, such as devices operating based on user feedback, which can include sensory feedback, such as visual feedback, auditory feedback, tactile feedback, and any other feedback. The input from the user can be received in any form, such as acoustic input, speech input, tactile input, or any other input.

The subject matter described herein can be implemented in a computing system that can include at least one of a back-end component, a middleware component, a front-end component, and one or more combinations thereof. The back-end component can be a data server. The middleware component can be an application server. The front-end component can be a client computer having a graphical user interface or a web browser or an application software, through which a user can interact with an implementation of the subject matter described herein. The application software can be installed on a computing device, such as a tablet computer, a smartphone, a smart television set, a laptop computer, a desktop computer, and/or any other computer or computing device. The components of the system can be interconnected by any form or medium of digital data communication, such as a communication network. Examples of communication networks can include a local area network, a wide area network, internet, intranet, Bluetooth network, infrared network, or other networks.

The computing system can include clients and servers. A client and server can be generally remote from each other and can interact through a communication network. The relationship of client and server can arise by virtue of computer programs running on the respective computers and having a client-server relationship with each other.

Although a few variations have been described in detail above, other modifications can be possible. For example, the logic flows depicted in the accompanying figures and described herein do not require the particular order shown, or sequential order, to achieve desirable results. Some terms that may have been used with different reference numerals can refer to same or similar elements. Other implementations may be within the scope of the following claims.

What is claimed is:

1. A method comprising:
receiving, by at least one data processor connected to a user device of a user and from a content server, content of a video channel when the user is either subscribed to the video channel or connected to a subscriber of the video channel on a social network;
receiving, by the at least one data processor and from a user input device connected to the user device, a first set of one or more commands input by the user on the user input device; and
transmitting, by the at least one data processor and to a graphical user interface of the user device, the content of the video channel arranged based on the first set of one or more commands and based on a display design, the graphical user interface displaying the arranged content of the video channel according to the display design.

2. The method of claim 1, wherein:
the at least one data processor is embedded in a set top box; and
the user input device is a remote control device.

3. The method of claim 1, wherein the at least one data processor is connected to the user device via a wireless communication network.

4. The method of claim 1, wherein:
the at least one data processor is embedded in the user device, the at least one data processor executing a software application performing tasks of a set top box; and
the user input device is at least one of a keyboard of a computer used by the user, and a touchscreen on the computer.

5. The method of claim 1, wherein the user input device comprises a keypad to receive the first set of one or more commands in a textual format.

6. The method of claim 1, wherein the arranged content is displayed on the graphical user interface in a plurality of graphical elements comprising: a video playback area, a main interaction area, a clock panel, a menu bar panel, a notification panel, a contacts panel, a voice living room panel, and a discovery grid window.

7. The method of claim 6, wherein:
the video playback area displays a video of the video channel;
the main interaction area displays instruction data received from the user on the user input device, the instruction data determining one or more graphical elements of the plurality of graphical elements and associated content that are to be displayed simultaneously on the graphical user interface;
the clock panel displays a current time;
the menu bar panel comprises: a friends tab to hide a display of contacts of the user on the social network in the main interaction area, a privacy tab to activate or deactivate privacy of the user in order to share or prevent data identifying the video channel being displayed to the user, a chat tab to select recipients of one or more messages to be sent by the user, and a history tab to display a chat history of the user in the notification panel;
the notification panel displays messages between the user and one or more contacts of the user on the social network; the contacts panel displays contacts of the user that are currently being displayed corresponding video channels;
the voice living room panel displays contacts on the social network that are in a current voice session with the user; and
the discovery grid window displays channels filtered according to at least one of: favorite channels, popular channels, genre, type, alphabetically, numerical order of channel numbers, and subscription status of the user.

8. The method of claim 7, wherein the notification panel executes a fade-out animation so that messages received or sent more than a predetermined time ago are automatically removed from display in the notification panel.

9. The method of claim 7, wherein the genre comprises at least one of: language of programs displayed, lifestyle, news, sports, and business.

10. The method of claim 6, wherein the content of the video channel is displayed simultaneously in two or more graphical elements when there is no conflict in a control of the two or more graphical elements by the user input device.

11. The method of claim 6, wherein the main interaction area comprises: an emoticon area, a message composition panel, a contacts list panel, and an electronic program guide (EPG) channel surf panel.

12. The method of claim 11, wherein the content of the video channel comprises unique emoticons comprising: vegetables, fruits, flowers, animals, and food.

13. The method of claim 12, wherein the graphical user interface displays an enlarged copy of a unique emoticon in the video playback area when the user: presses a unique emoticon button on the user input device to activate a unique emoticon mode, selects the unique emoticon from the emoticon area, and performs a preset movement with the user input device.

14. The method of claim 13, wherein the preset movement of the user input device comprises one or more of: a rotation of the user input device, and a quick movement of the user input device in a particular direction.

15. The method of claim 1, further comprising:
receiving, by the at least one data processor, a second set of one or more commands characterized by a three-dimensional movement of the user input device by the user, the at least one data processor determining the three-dimensional movement based on a tracking of the user input device by one or more gyroscopic sensors embedded in the user input device;
generating, by the at least one data processor, data characterizing a figure based on the second set of one or more commands; and
transmitting, by the at least one data processor and to the graphical user interface, the data characterizing the generated figure, the graphical user interface displaying the figure.

16. The method of claim 15, wherein a graphical user interface of a user device of another user that is a contact of the user on the social network displays the figure when the figure is displayed on the graphical user interface of the user device of the user.

17. The method of claim 1, further comprising:
receiving, by the at least one data processor, another set of one or more commands characterized by an accelerating movement of the user input device by the user, the at least one data processor determining the accelerating movement based on a tracking of a movement of the user input device by at least one accelerometer embedded in the user input device; and
transmitting, by the at least one data processor and to the user device, the another set of one or more commands, the user device vibrating on receipt of the another set of one or more commands.

18. The method of claim 17, wherein a user device of another user that is a contact of the user on the social network vibrates when the user device of the user vibrates.

19. The method of claim 1, wherein the user device is attached to one or more cameras that enable video-conferencing between the user and one or more contacts of the user on the social network.

20. A non-transitory computer program product storing instructions that, when executed by at least one programmable processor, cause the at least one programmable processor to perform operations comprising:
receiving, at a graphical user interface of a first user device of a first user connected to a second user on a social network, one or more commands provided by the first user on a remote control device connected to the first user device via a first communication network;
retrieving, at the graphical user interface of the first user device and based on the one or more commands, data of a video channel being displayed on a graphical user interface of a second user device of the second user; and
displaying, according to a display design on the graphical user interface of the first user interface device, the data of the video channel in synchronization with display of the video channel on the graphical user interface of the second user device.

21. A system comprising:
a first user device of a first user, the first user being followed by a plurality of followers on a social network, the first user device connected to a first remote control device configured to receive a commentary by the first user;
a plurality of user devices of the plurality of followers, each user device of the plurality of user devices being connected to a corresponding remote control device of a plurality of remote control devices; and
a plurality of servers connected to the first user device and the plurality of user devices via a communication network, the plurality of servers relaying and synchronizing an event hosted on the video channel to the first user and the plurality of followers, the plurality of servers receiving the commentary from the first remote control device when the event is being displayed, the plurality of servers relaying the commentary to the plurality of user devices of the plurality of followers in real-time.

22. The system of claim 21, wherein:
the plurality of servers comprise a content server and a management system;
the first user device is associated with a set top box; and
the plurality of user devices are associated with a corresponding plurality of set top boxes.
